(19) United States
(12) Patent Application Publication
(10) Pub. No.: US 2022/0398888 A1
(43) Pub. Date: Dec. 15, 2022

(54) DEVICE AND METHOD FOR MONITORING ELECTRICALLY CONDUCTIVE SECURITY FEATURES, AND MONITORING DEVICE FOR ELECTRICALLY CONDUCTIVE SECURITY FEATURES

(71) Applicant: Prismade Labs Gmbh, Chemnitz (DE)

(72) Inventors: Karin Weigelt, Chemnitz (DE); Jan Thiele, Chemnitz (DE)

(73) Assignee: Prismade Labs Gmbh, Chemnitz (DE)

(21) Appl. No.: 17/610,626

(22) PCT Filed: May 13, 2020
(86) PCT No.: PCT/EP2020/063288

§ 371 Date: Aug. 29, 2022

(30) Foreign Application Priority Data
May 13, 2019 (DE) 10 2019 112 388.7
Mar. 25, 2020 (DE) 10 2020 108 309.2

(51) Int. Cl. G07D 7/026; G07D 7/162; G08B 13/14

(52) U.S. Cl. CPC G07D 7/026; G07D 7/162; G08B 13/149

(57) ABSTRACT

A method for verifying an object preferably a document, a (bank) card and/or a product package is provided with an electrically conductive security feature on a device with a capacitive surface sensor. After the object with the security feature is placed on the surface sensor, in particular a dynamic input is performed on the object and the electrically conductive security feature using an input means for generating a characteristic time-dependent signal on the surface sensor. The detected time-dependent signal is subsequently evaluated. Furthermore, an object with a security feature or method for its production, system or kit for carrying out the method and for verifying a document is provided with a conductive electrical security feature on a capacitive surface sensor.

The invention preferably relates to a method for verifying an object, preferably a document, a (bank) card and/or product packaging, comprising an electrically conductive security feature, on a device comprising a surface sensor as well as an object with security feature or method for its production, system or kit for implementing the method and for verifying a document with a conductive electrical security feature on a capacitive surface sensor.

### BACKGROUND AND PRIOR ART

The invention relates to, but is not limited to, a secure and simple method for verifying or authenticating electrically conductive security features, for example, holograms, security strips, security threads and patches.

The aforementioned security features are applied, inter alia, as authenticity features on documents, bank notes, securities, identification cards and documents, as well as on high-value products and packaging, and serve to protect documents against forgery. Electrically conductive security features in general and holograms in particular are difficult to forge or imitate compared to other print patterns or print structures and are therefore used to protect valuable documents. However, for consumers and end users, electrically conductive security features, such as holograms, are difficult to verify for authenticity and/or originality. The security features are usually inspected visually by the end user. In particular, color-change effects, motion effects, 3D effects and other effects that become visible under certain conditions are inspected. The detectability of such effects is influenced, for example, by illumination, viewing angle, movement of the document, etc. In summary, a lot of knowledge about the respective security feature is required to make a statement about authenticity. This knowledge is usually not available to the end user and is also difficult for the publisher of the respective document to communicate.

Thus, there is a need to provide methods for authenticating electrically conductive security elements that are readily accessible to the end user and do not require subjective judgment by the observer.

In the prior art, various methods exist for testing electrically conductive security features.

EP1760670 describes a device for the verification of holograms by optical methods.

Most of the methods known from the prior art are based on optical methods and in any case require special devices to evaluate or verify the security features. Thus, these methods are not suitable for use by the end consumer, but primarily address stakeholders along the value chain, e.g. wholesalers, intermediaries, banks, authorities, etc.

Some methods based on electronic interactions are also known from the prior art.

US 2001054901 describes a method for inspecting the authenticity of optically diffractive features, wherein an electrical voltage is applied to the feature and a signal is detected and compared with a stored signal.

WO 2012038434 describes a capacitive information carrier, in which at least one electrically conductive touch structure is arranged on an electrically non-conductive substrate, and a system and method for recording information comprising a capacitive information carrier, a capacitive surface sensor, a contact between the two elements and an interaction which makes the touch structure of the information carrier evaluable by a data processing system connected to the surface sensor and which can trigger events associated with the information carrier. The claimed touch structure is characterized in that it replicates the characteristics of fingertips. Information is gathered from the information carrier by means of a capacitive surface sensor evaluating position data. This method has some disadvantages, which will be explained in more detail below.

DE 102012023082 describes a method for the interaction of a flat, portable data carrier, in particular a value document, with a terminal device. The evaluation is based on position data that are evaluated by a terminal device with a “capacitive display”. The evaluation is based on determining the positions at which or on which the touch-sensitive capacitive surface is influenced by an electrically conductive structure, i.e. the evaluation is based on static signals. This method of evaluation has some disadvantages, which will be explained below.

WO 2018/119525 A1 describes the retrieval of information from a security document by means of a capacitive touch screen. A capacitive signal is evaluated based on position data.

In all three documents mentioned, the identified signals are evaluated based on position. The evaluation of position data has some disadvantages. In particular in application WO2012038434 and DE102012023082 it is necessary that the electrically conductive structure to be detected has certain structural features. This is often realized in the form of circles or ellipses. These elements are designed in such a way that they simulate the properties of fingertips when in effective contact with a capacitive surface sensor.

For example, the circles are often interconnected by electrically conductive line structures and have diameters in the range of 8 mm+/−3 mm.

The capacitive touch screens currently in use are designed to recognize input from human fingers as reliably as possible. In order to “use” such screens as input devices for electrically conductive structures, the design of the electrically conductive structures has been adapted as far as possible to input from fingers or styluses. If the electrically conductive structures are significantly smaller, they are generally not recognized or are ignored by the touch controller of the capacitive touch screen. If the electrically conductive structures are significantly larger, the detected positions are not reproducible or differentiable. Furthermore, when electrically conductive elements that are too large come into contact with capacitive touch screens, a so-called “cancel event” generally occurs, i.e. the corresponding information is not evaluated or is ignored/filtered out by the touch controller.

This results in narrow limits or strict design rules for electrically conductive structures if they are to be reliably and reproducibly detected by capacitive touch screens. In other words, the design freedom for such structures is severely limited and largely determined by the readout technology.

This has a detrimental effect on the provision of security features that are as tamper-proof as possible.

In application WO 2018/119525 A1, a finger or a stylus is swiped along an inhomogeneous surface while the security document is in active contact with the capacitive touch screen. “The capacitive signal [is evaluated] as a function of position”, wherein access to raw data appears to be required.

Application WO 2018/119525 A1 only describes material-related variations of the inhomogeneous structure, and does not address the design or form of the inhomogeneous structure. In the graphics, generic patterns for the inhomogeneous regions are shown such as strips of different widths. The inhomogeneous regions cover large parts of the bank note or security document.

In summary, the methods described in the prior art for capacitive detection of security features are, on the one hand, very limited with respect to the design of the security element and, on the other hand, are not conducive to being read out by the terminal devices widely used in the market, such as smartphones or tablets, since access is generally not granted to the raw data of the capacitance values.

### OBJECTIVE OF THE INVENTION

The object of the present invention is to provide a method for verifying electrically conductive security features with significantly increased freedom in the design and configuration of the security features compared to the prior art. In particular, it is an objective of the invention to enable practical detectability or verification of objects, for example documents, by means of terminal devices (smartphones, tablets) which are widely used in the market and are capable of reproducibly detecting the electrically conductive security features without further modifications to the device.

### SUMMARY OF THE INVENTION

The objective is solved by the features of the independent claims. Preferred embodiments of the invention are described in the dependent claims.

In one aspect, the invention preferably relates to a method of verifying an object having an electrically conductive security feature on a device having a capacitive surface sensor comprising the steps of
a. provision of a device comprising a capacitive surface sensor
b. provision of an object with an electrically conductive security feature
c. placing the object on the capacitive surface sensor
d. making a dynamic input on the object using an input means for generating a characteristic time-dependent signal on the surface sensor
e. evaluating the time-dependent signal detected on the surface sensor during input, wherein the evaluation comprises detecting edges within the electrically conductive security feature.

The present invention describes a method for authentication or verification of electrically conductive security features, for example holograms, by means of capacitive surface sensors. A special form of capacitive surface sensors is capacitive touch screens, which are nowadays included in all common smartphones as a combined input and output interface. Capacitive surface sensors can also be specially designed and configured for specific applications.

Electrically conductive security features, in particular holograms, usually comprise a metallized layer, i.e. they are usually electrically conductive. If electrically conductive structures or elements are brought into effective contact with a capacitive surface sensor, local capacitive interactions take place between the electrically conductive elements and the surface sensor, i.e. the security feature or the hologram locally changes the capacitance in the surface sensor. This local capacitance change can be detected by the electronic evaluation system of the surface sensor and processed further by means of hardware and software.

The present invention enables an electronic and significantly more secure inspection of a security feature, which until now could only be evaluated optically, with the aid of devices which are available to virtually every citizen. In other words, the method for verifying the authenticity of the security features is not exclusive, but is available to a very broad target group.

Both in the area of value documents, e.g. bank notes, and valuable documents used for identification purposes, such as ID cards, passports, means of identification, visa stickers, birth certificates as well as deeds, notarized documents, etc., counterfeiting is becoming increasingly common. Branded products, medicines or other high-value goods are also counterfeited and pose a potential threat to the end consumer or other participants in the value chain.

The authentication method according to the invention is preferably characterized by an interactive interaction between the user, the security feature and the smartphone or inspection device. The improved inspection of the security feature, as described herein, results in the possibility on the application side to use these security features, or the documents that use them, as access keys to digital applications.

For example, users can independently check the authenticity of a bank note electronically on their smartphones. After verification, the bank note activates on the smartphone, for example, additional information such as notes on further security features on the bank note or exchange rates. This recognition function can also be used to communicate in a barrier-free manner the type, denomination or other information of the bank note acoustically, visually or via other methods.

Likewise, means of identification or payment cards can be equipped with an individual security feature that can be read electronically according to the invention. This enables, in addition to the electronic verification of authenticity, the simultaneous recognition of the user and thus access to a digital user account, either via a reader in, for example, a bank branch or directly on the user's smartphone. Especially in the field of e-government and e-banking, this invention thus enables the provision of a novel and secure access key to digital services.

The inventors have succeeded in developing rules for the structural design which have as little restrictive effect as possible on the optical design of the electrically conductive security features and even integrate themselves into the optical design and at the same time enable reproducible evaluation by capacitive surface sensors. Surprisingly, such a structural design can be achieved in particular by providing edges within the structure of the security feature.

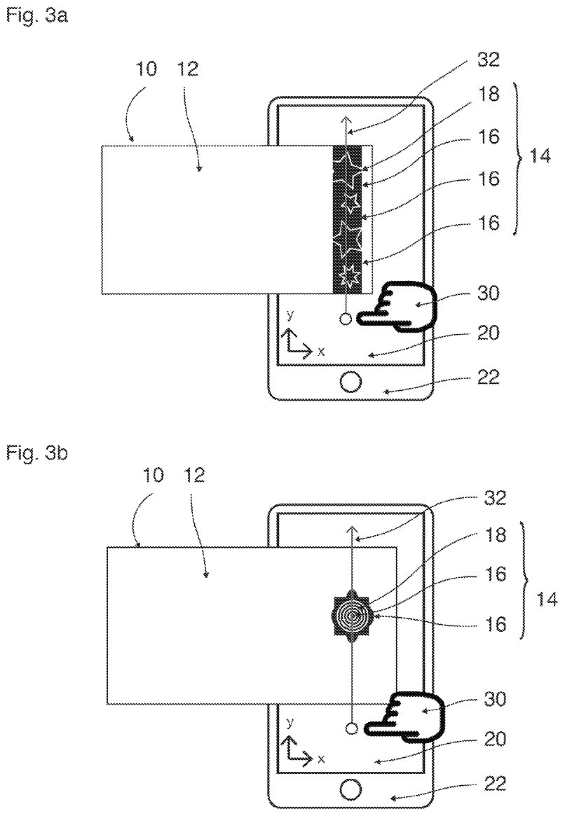

The term edge is preferably understood to mean a transition between a conductive region and a non-conductive region within the security feature. Here, for example, conductive and non-conductive regions can alternate in the form of strips. Likewise, non-conductive interruptions of any line shape, for example rectilinear, circular, elliptical, rectangular, triangular, star-shaped, etc., may be present in a planar, largely homogeneous, electrically conductive region (see FIG. 3-6). The transitions between the planar electrically conductive region and the non-conductive interruptions represent edges within the meaning of the invention. In the transverse profile along a preferred direction, edges within the meaning of the invention are thus preferably characterized by an abrupt rise (or fall) of conductive material at a transition from a non-conductive region to a conductive region (or vice versa). Abruptly preferably means an increase or decrease over a distance which is extremely small compared to the dimensions of the conductive and non-conductive regions. In the transverse profile, an edge is preferably characterized by a substantially perpendicular rise or fall in conductive material. According to the invention, it was recognized that inhomogeneities occurring as edges can be detected particularly reliably by a preferably linear swiping movement.

In addition, any designs for structuring can be provided very freely by demetallization—even retrospectively—whereby a particularly secure coding can take place. The demetallization can preferably comprise a removal of, for example, strip-shaped regions from a metallic security feature. Advantageously, demetallization can also be used to introduce line-shaped interruptions of any other design (circular, elliptical, rectangular, triangular, star-shaped, etc.) into a planar, preferably homogeneous, electrically conductive regions. By providing a variety of design options, security features can be individually coded to a particularly high degree in order to meet the highest security requirements.

This method of evaluating or inspecting an electrically conductive security feature can also be referred to as determining a so-called “capacitive footprint”. From the prior art, no method is known so far to specifically detect edges of electrically conductive structures and thus to determine the shape of almost any designed elements with the aid of a capacitive touch screen and without access to raw data. This method allows great amount of design freedom in the design of electrically conductive security elements.

It should be noted that currently common capacitive touch screens do not output capacitance values. As a developer of applications (apps or websites), one usually does not have access to so-called raw data or capacitance values. These data are recorded and pre-processed by the touch controller, an integrated circuit, from the electrode grid of the surface sensor and output in the form of so-called touch events. This information about touch events, which is available to the developer of applications, usually includes the information ID (number of the respective touch), type (touch start, touch move, touch end, touch cancel), x-coordinate, y-coordinate and time stamp. Under certain conditions, developers have access to additional information, such as the diameter of the touch or input. In the development of applications or apps, one must limit oneself to this data.

The method described in WO 2018/119525 A1 for detecting inhomogeneous regions with small 10-percent deviations in the thickness of the security document, the permittivity or the electrical conductivity is not feasible without access to capacitance values or raw data from the surface sensor and is therefore not applicable with the aid of current smartphones or terminal devices. Only by a very complex evaluation of raw data from a surface sensor would such an evaluation be theoretically feasible. In practice, the raw data are not accessible to developers of corresponding software programs or applications. A simple transfer to an evaluation using data provided by common touch controllers is not possible.

Instead, the method according to the invention permits a significantly simplified evaluation, which is also made possible in particular by means of commercially available smartphones.

Preferably, the invention relates both to a device in the form of a security feature or a document comprising such a security feature and to a method for inspecting the security feature.

The security feature preferably comprises at least one electrically conductive structure. Since the electrically conductive security feature is characterized in particular by the structuring of the electrically conductive structure, the terms electrically conductive security feature and electrically conductive structure can be used partially synonymously.

In practice, this security feature is applied to an object or item to be protected. Within the meaning of the invention, an item to be protected or an object to be protected is in particular a document or card-like object to be protected. The terms are preferably used synonymously. The object may also be referred to as a verification object within the meaning of the invention.

In a preferred embodiment, the method is characterized in that the object is a document, preferably a bank note, a card-like object, preferably a bank card or credit card, and/or a product package.

Objects to be protected may include, for example, the following:
documents, e.g. deeds, contracts, chattel paper, birth certificates
notary documents
securities, bank notes, checks
bank cards, credit cards
means of identification, ID cards, employee means of identification, means of identification for access control systems
warranty certificates, medicinal product packaging, product packaging, hangtags
product protection labels, labels, security stickers, stickers
without being limited to the foregoing.

In a further preferred embodiment, the security feature according to the invention is preferably applied to an electrically non-conductive substrate material, e.g. paper, cardboard, synthetic paper, bank note paper, laminates, plastics, foils, wood or other electrically non-conductive substrates or carrier materials. The object thus preferably comprises a non-conductive substrate, e.g. the paper of a bank note, and an electrically conductive security feature applied to the substrate. Non-conductive regions are preferably constituted by the substrate, while the conductive regions are defined by the security feature. The transition between conductive and non-conductive regions preferably characterizes those edges which can be detected in accordance with the invention. In preferred embodiments, the method for verifying the authenticity of the security feature may comprise the following steps:
Provision of an electrically conductive security feature (applied to a document or product)
Provision of a terminal device, e.g. a smartphone, which is equipped with a capacitive touch screen.
Provision of software (app) or access to a website on the terminal device
Placing the security feature or the document including the security feature on the capacitive touch screen of the terminal device
Performing an input with the aid of an input means, e.g. with the aid of a finger, for example by performing a swipe gesture with the finger across the security feature while the document including the security feature is resting on the capacitive touch screen of the terminal device
Recording and processing of the so-called touch data, which the terminal device provides for further processing in the software.
Evaluating, inspecting, comparing or decoding the touch data and displaying the result of the security inspection on the device or performing a specific action on the device.

In preferred embodiments, the electrically conductive security feature may include the following features.

In a preferred embodiment, the electrically conductive security feature comprises a metal and/or other conductive material which is preferably structured. Minimum or maximum structure variables are preferably generated from the geometry of the electrode grid (of a surface sensor) as well as from the geometry of a finger/input means.

The invention preferably further comprises an object and a method for inspecting or verifying an apparatus (preferably a document). The inspection of the object may aim to determine the authenticity or originality of the security feature. The inspection of the apparatus is performed by means of a capacitive surface sensor, for example by means of the capacitive touch screen of a smartphone or other terminal device. The advantage of using such a terminal device is primarily its wide distribution and constant availability. Thus, documents can be inspected at any time in any place. Capacitive touch screens are primarily designed for operation by means of finger gestures. The versatile operation of graphical user interfaces is possible by means of different gestures, e.g. tapping, swiping with one or more fingers, zooming and other variations. Technologically, capacitive touch screens usually consist of a grid of transmitting and receiving electrodes, which are arranged orthogonally to each other, for example.

Within the meaning of the invention, the term “capacitive surface sensor” preferably refers to input interfaces of electronic devices. A special form of a “capacitive surface sensor” is the touch screen, which in addition to the input interface also serves as an output device or display. Devices with a capacitive surface sensor are able to perceive external influences or interactions, for example touches or contacts on the surface and to evaluate them by means of associated logic. Such surface sensors are used, for example, to facilitate the operation of machines. Typically, surface sensors are provided in an electronic device, which may be, but is not limited to, smartphones, mobile phones, displays, tablet PCs, tablet notebooks, touchpad devices, graphics tablets, televisions, PDAs, MP3 players, trackpads and/or capacitive input devices.

Preferably, these are multi-touch capacitive surface sensors. Such surface sensors are preferably configured to detect multiple touches simultaneously, allowing for example elements displayed on a touch screen to be rotated or scaled.

The sequence of terms “device including a surface sensor” or “device comprising a surface sensor” preferably refers to electronic devices, such as the aforementioned, which are capable of further evaluating the information provided by the capacitive surface sensor. In preferred embodiments, the devices are mobile terminals. Throughout this document, the terms “terminal” and “device” are used as synonyms for each other and may each be replaced by the respective other term.

Touch screens are preferably also referred to as tactile screens, surface sensors or sensor screens. A surface sensor need not necessarily be used in conjunction with a display or a touch screen, i.e. need not necessarily have a display. It may be equally preferred within the meaning of the invention that the surface sensor is visibly or non-visibly integrated in devices, objects and/or apparatuses.

Surface sensors comprise in particular at least one active circuit, preferably referred to as a touch controller, which may be connected to a structure of electrodes. Surface sensors are known in the prior art whose electrodes comprise groups of electrodes which differ from one another, for example in their function. This structure of electrodes is preferably also referred to as an “electrode grid” within the meaning of the invention. It is preferred within the meaning of the invention that the electrode grid of a surface sensor comprises groups of electrodes, wherein the groups of electrodes differ from each other, for example in their function. These may be, for example, transmitting and receiving electrodes which, in a particularly preferred arrangement, may be arranged in column and row form, i.e. in particular constitute nodes or intersections at which at least one transmitting and one receiving electrode intersect or overlap with one another. Preferably, the intersecting transmitting and receiving electrodes are aligned with respect to one another in the region of the nodes in such a way that they form substantially 90° angles with one another.

Terms such as substantially, approximately, about, etc. preferably describe a tolerance range of less than ±20%, preferably less than ±10%, even more preferably less than ±5% and particularly less than ±1%. Specifications of substantially, approximately, about, etc. always also disclose and comprise the exact value mentioned.

An electrostatic field is preferably constituted between the transmitting and receiving electrodes of the surface sensor, which reacts sensitively to changes or capacitive interactions. These changes can be caused, for example, by touching the surface of the surface sensor with a finger, a conductive object and/or an electrically conductive structure. Capacitive interaction, for example an outflow of charges to the finger or a conductive object, leads in particular to local changes in potential within the electrostatic field, which is preferably caused by the fact that, for example, the electrical field between the transmitting and receiving electrodes is locally reduced as a result of being touched by a contact surface of an electrically conductive structure. Such a change in the potential conditions is preferably detected and further processed by the electronics of the touch controller.

For this purpose, it is preferred that the touch controller controls the electrodes in such a way that a signal is transmitted between one or more transmitting electrodes and one or more receiving electrodes in each case, which signal can preferably be an electrical signal, for example a voltage, a current or a potential (difference). These electrical signals in a capacitive surface sensor are preferably evaluated by the touch controller and processed for the operating system of the device.

The information transmitted from the touch controller to the operating system describes so-called individual “touches” or “touch events”, each of which can be thought of as individual detected touches or can be described as individual inputs. These touches are preferably characterized by the parameters “x-coordinate of touch”, “y-coordinate of touch”, “timestamp of touch” and “type of touch”. The parameters “x-coordinate” and “y-coordinate” describe the position of the input on the touch screen. Each pair of coordinates is preferably associated with a timestamp describing when the input occurred at the corresponding location. The parameter “type of touch event” describes the detected state of the input on the touch screen. Inter alia, the types Touch Start, Touch Move, Touch End and Touch Cancel are known to the person skilled in the art. A touch input on the capacitive surface sensor can be described with the aid of the parameters Touch Start, at least one Touch Move and Touch End as well as the associated coordinates and time stamps.

It is preferred, and known in the prior art as multi-touch technology, that multiple touch inputs can be evaluated simultaneously. Projected capacitance touch technology (PCT) is an example of such technology that allows multi-touch operation.

In the standard use of mobile terminals, the electrical field between the electrodes is locally reduced as a result of being touched by a finger or an electrically conductive object, i.e. “charges are drawn off”. Similarly, placing an object with an electrically conductive security feature on the touch controller and making a dynamic input on the same using input means also changes the electrical field and generates a characteristic signal or is detected by the touch controller.

Within the meaning of the invention, the “signal generated or detected on the surface sensor during dynamic input” is preferably understood to mean the signal which is detected by the surface sensor as a result of the capacitive interaction between the electrically conductive structure, input means and surface sensor during the input sequence. It is thus preferably a dynamic signal, for example in the form of sequential coordinate positions of touch events, which are processed by the surface sensor. The detected or generated signal is therefore preferably also referred to as a time-dependent signal. Alternatively, the detected or generated signal is preferably also referred to as a path-dependent signal. The “path” preferably refers to the input gesture or the path covered by the input means during the input sequence and the resulting sequential coordinate positions of touch events.

Within the meaning of the invention, the input means are preferably fingers or special styluses, for example touch pens. Preferably, the input means are capable of changing a capacitive coupling between row and column electrodes within the surface sensor. Preferably, the input means are configured to trigger a touch event on a capacitive touch screen. In particular, since touch screens are optimized for human finger input, any input means that mimic the shape, size, and/or capacitive interactions between a finger and a surface sensor may be preferred.

The diameter of the contact area of a finger on the capacitive touch screen is approximately 7-8 mm. Most commercially available touch screens are optimized for the exact position detection of touch inputs in this range. If the touch screen is now to be used to detect electrically conductive structures, certain boundary conditions regarding minimum and maximum size must be observed in the design (size, shape, geometry, outline, internal structuring, etc.) of the electrically conductive structure. As described above, this results in narrow limits or strict design rules for electrically conductive structures if they are to be reliably and reproducibly detected by capacitive touch screens. In other words, the design freedom for such structures is severely limited and largely determined by the readout technology. It was completely surprising that by making minor adjustments in the design of electrically conductive structures, almost any design of electrically conductive security features can be capacitively read. Thus, electrically conductive security features can be provided that meet both the requirements for attractive appearance and the requirements for ease of inspection that can be performed by the end user.

If the electrically conductive structures are read out based on position data, as is common in the prior art, the electrically conductive structures are limited with regard to the minimum and maximum size of the individual elements, the arrangement of conductive paths/connections and the distance between the individual elements.

If the electrically conductive structures are significantly smaller than the average diameter of the contact point of a finger on the touch screen (7-8 mm), such electrically conductive individual elements are usually not detected or ignored by the touch controller of the capacitive touch screen. Depending on the device, elements with a diameter <3-5 mm are affected by this.

If the electrically conductive structures are significantly larger than the average diameter of the contact point of a finger on the touch screen (7-8 mm), the detected positions are not reproducible or differentiable. Depending on the application, such inputs are, for example, ignored by the touch controller within the scope of the so-called “palm rejection” (recognition of unwanted inputs by the ball of the hand) or, in the case of effective contact of electrically conductive elements that are too large with capacitive touch screens, the so-called “touch cancel event” occurs, i.e. the corresponding information is not evaluated or is ignored/filtered out by the touch controller.

If the electrically conductive structures comply with the above-mentioned restrictions regarding size, the distance between the elements is also important for reliable and reproducible detection. If two individual elements are too close together, the touch controller interprets the input not as two individual elements, but as one larger element. This effect can be described as a merging of touch points and occurs at distances <6-10 mm (center to center) depending on the terminal or touch controller.

Due to the aforementioned limitations, the design freedom of the electrically conductive features described in the prior art is severely restricted. The present invention describes a new method for capacitive reading of electrically conductive structures, which consequently allows significantly greater design freedom in the design of electrically conductive security features. In contrast to the position-based evaluation of touch events, the inventors have developed a time-based or time-dependent evaluation of touch data which is much more flexible, tamper-proof and at the same time more robust.

In a preferred embodiment, the electrically conductive security feature comprises at least two individual elements that are galvanically separated from one another, wherein, preferably, when a dynamic input is performed on the electrically conductive security feature, initial and/or end regions of the individual elements or front or rear sides of the individual elements can be detected as edges. The dynamic input may, for example, be a substantially rectilinear swiping movement of the input means over the entire security feature. Jumps in a velocity profile may preferably be exploited as described for detecting the edges.

In a further preferred embodiment, the method is characterized in that the geometry of the electrically conductive security feature, preferably its shape, outline, contour and internal structuring, in particular with regard to the presence of edges, determines the curve of the time-dependent signal in the capacitive surface sensor. The term “internal structuring” or also “internal structure” preferably characterizes the distribution of conductive and non-conductive regions within the (overall) outline of a security feature.

The internal structuring of the security feature can preferably be defined by the individual elements arranged within the security feature. The arrangement of the individual elements, their geometric design and the edges generated by them give the security feature an individual internal structure.

A security feature which is designed with a smaller number of wider, strip-shaped individual elements has, for example, a different internal structure than a security feature which is designed with a larger number of thinner, strip-shaped individual elements, whereby the overall external geometry of the two security features can be identical.

Particularly preferably, individual internal structuring of the security features can be carried out by demetallization, i.e. a preferably subsequent removal of conductive regions from a planar layer. With reference to the above example, different numbers and dimensions of strips can be removed from security features having an identical external shape in order to obtain different internal structures.

Advantageously, in addition to strip-shaped modifications, any other internal structuring can be provided and reliably differentiated by means of the method. For example, a plurality of different line-shaped interruptions (including circular, elliptical, rectangular, triangular, star-shaped, etc.) can be introduced into a homogeneous region. Security features with highly individualized “internal structures” can be obtained both by the positioning of the interruptions, e.g. a positioning of stars, circles, spirals, etc., and by their designs, (see FIG. 3-6).

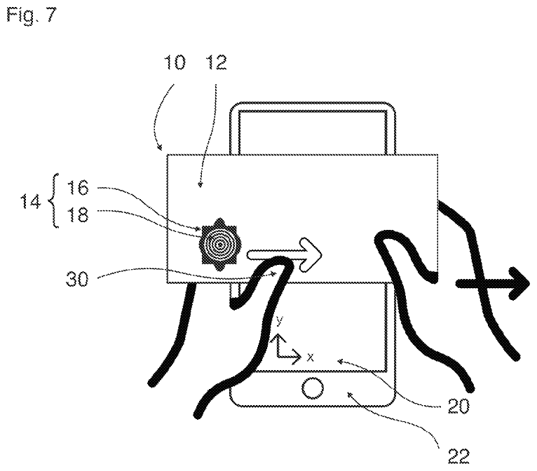

The insertion also of complex line-shaped interruptions preferably leads to the formation of galvanically separated individual elements. For example, the introduction of successive circular interruptions (see FIG. 7) creates a large number of galvanically separated individual elements. The innermost individual element has a circular shape and is surrounded by increasing annular individual elements which are enclosed by an outer individual element. The line-shaped interruptions may have small line widths of, for example, less than 3 mm, preferably less than 2 mm, particularly preferably less than 1 mm, it being preferred that the line shaped interruptions have a line width of at least 10 μm, preferably at least 50 μm, particularly preferably at least 100 μm.

A position-based evaluation of touch events when placing such a modified security feature on a surface sensor cannot come close to resolving the complex structure. In contrast, the edge detection according to the invention allows even such complex structures to be distinguished on the basis of an evaluation of the velocity profiles of the touch events. Advantageously, no complete characterization of the internal structure is necessary for verification purposes. Rather, it is sufficient for the detectable edges to generate a characteristic signal for a preferred direction which is sufficiently different from security features with other modifications.

In a further preferred embodiment, the method is characterized in that the electrically conductive security feature comprises at least two individual elements which are galvanically separated from one another, wherein, preferably, when a dynamic input is performed on the electrically conductive security feature, initial and/or end regions of the individual elements or interruptions in the conductive security feature can be detected as edges.

Within the meaning of the invention, initial and end regions of individual elements are edge regions of these individual elements, wherein a first edge region of an individual element is detected during a dynamic input along a preferred direction or direction of movement at a first (start) time and a second edge region is detected at a second (end) time.

In another preferred embodiment, the method is characterized in that the dynamic input comprises a substantially rectilinear swipe motion of the input means over the entire security feature, the swipe motion being parallel or orthogonal to the largest dimension of the security feature.

Preferably, the swipe movement may be repeated several times along a swipe direction and/or along oppositely alternating swipe directions.

A substantially rectilinear swipe motion across the security feature is preferably a motion that has continuous contact with the security feature along a preferred direction or swipe direction without change of direction or pitch.

This movement can be repetitive, so that after completion of a movement the contact of the input means with the security feature is ended—for example by removing the input means. Subsequently, the swipe movement can be repeated starting from the starting point of the previously performed swipe movement along the same swipe direction. The starting point or end point does not have to be determined exactly. Rather, it is sufficient to select it preferably outside the outer contour of the security feature so that the latter is completely swiped.

In a further embodiment, the rectilinear swiping motion may be repeated in reverse. In this respect, a subsequent swiping movement from the end point of a preceding swiping movement is mirror-reversed in comparison to the preceding movement, wherein the input means preferably does not cease the contact between the preceding and subsequent swiping movements. Particularly preferably, swiping movement sequences with oppositely alternating swiping directions can also be performed repeatedly. In everyday language, this can be understood, for example, as “swiping back and forth” or “rubbing”.

The dimensions of a security feature preferably correspond to the distance between two substantially diametrically opposed edge points associated with the security feature, the largest possible dimensions preferably being the largest possible distance between two such edge points on the security feature.

The person skilled in the art is further able to adapt the described embodiments of the method with respect to the terms “parallel” and “orthogonal” to other orientations or embodiments. For example, the person skilled in the art will understand how to adapt the methods accordingly when the swipe movement is not parallel or orthogonal to the largest dimension of the security feature, so that all the advantages according to the invention are still applicable. Thus, the person skilled in the art knows to what extent they can deviate from the features “parallel”, “orthogonal” and still implement the advantages according to the invention.

In a further preferred embodiment, the method is characterized in that a plurality of conductive and non-conductive regions alternate along at least one preferred direction of the security feature, so that the transition between conductive and non-conductive regions can be detected as edges when a dynamic input is performed along the preferred direction. The conductive regions can also be understood as individual elements which are galvanically separated from each other by non-conductive regions. As explained above, the method according to the invention also allows a recognition or differentiation of complexly shaped individual elements on the basis of an edge detection, wherein the method preferably reliably recognizes the arrangement and/or shape of the individual elements by the successive occurrence of edges along a preferred direction.

It is preferred within the meaning of the invention that the time-dependent or path-dependent signal which is generated on a surface sensor by a relative movement between an input means and the security feature is changed by the structuring of the security feature, in particular its inhomogeneity or edges, and differs in particular from an input of an input means which is performed directly on a surface sensor, i.e. preferably without the use of the document or card-like object or without the presence of the electrically conductive security feature. In particular, two situations are distinguished: on the one hand, a direct dynamic input on a surface sensor with an input means and, on the other hand, a dynamic input in which a document or card-like object with an electrically conductive security feature is interposed between the input means and the surface sensor.

In this regard, it may be preferred to refer to the direct input with an input means on the surface sensor as the reference input. It is preferred within the meaning of the invention that the structure of the security feature effects a change in the direct dynamic input, whereby a time-dependent signal is generated on the surface sensor. In a preferred embodiment of the invention, it is intended that conductive and non-conductive regions of the electrically conductive security feature are formed with respect to size, spacing and shape in such a way that the time-dependent signal on the capacitive surface sensor resulting from the relative movement is changed with respect to the reference input with the input means, which takes place without using the security feature. This results in a modulation, definition, change, distortion or shift of the signal.

In a preferred embodiment of the invention, the resulting time-dependent or path-dependent signal on the capacitive surface sensor is at least partially altered with respect to position, velocity, direction, shape, intermittency of the signal, frequency and/or signal strength compared to a reference signal determined by a reference input with the input means, which is performed without using an electrically conductive security feature. It is preferred within the meaning of the invention that it is the resulting time-dependent signal which can preferably be generated by the proposed method. Based on an example input in the form of a straight, linear movement (substantially rectilinear swipe movement) on an individual element of the electrically conductive structure, this preferably means within the meaning of the invention that because of the modulation caused by the electrically conductive security feature, the generated time-dependent signal can have a different position, direction, form, velocity and/or signal strength compared to the straight, linear input of the input means, i.e. is detected by the surface sensor, for example, as being spatially offset, distorted and/or shifted, having a different shape from the straight, linear movement (substantially rectilinear swipe movement), pointing in a different direction or having an unexpected signal strength.

For example, when a user swipes their finger over a capacitive surface sensor as an example of use of an input means within the meaning of the invention, the surface sensor detects this movement substantially at the positions on the screen of the surface sensor which are actually touched by the finger, i.e. the input means. A straight, linear movement of the finger will preferably be detected by the surface sensor substantially as a straight, linear, uniform movement. Such an input without the presence of a card-like object is preferably referred to as a reference input within the meaning of the invention.

In the context of the present invention, it is preferably intended that an electrically conductive security feature is arranged between the input means and the surface sensor. Preferably, this security feature comprises electrically conductive individual elements.

It is envisaged in a possible embodiment of the invention that a user moves a finger over an object with a security feature, and in particular over the security feature. In this case, the object preferably rests on the surface sensor, so that the movement of the user's finger makes the individual elements of the electrically conductive structure that the user touches “visible” to the surface sensor by activating them. The inventors have recognized that by using an object comprising an electrically conductive security feature, an input on a surface sensor can be changed compared to a reference input. This change is preferably referred to as modulation within the meaning of the invention. It is preferably caused by the individual elements of the electrically conductive structure being activated by contact with the input means, allowing the surface sensor to detect them, the resulting time-dependent signal being spatially distorted by the arrangement of the individual elements on the object, for example, compared to a reference input. For example, if an input means is moved along an imaginary straight line on the object without an electrically conductive security feature, then the surface sensor would detect a linear movement of the input means as a reference input. However, if there is an object between the input means and the surface sensor on which individual elements of the electrically conductive structure are present, characteristic deviations occur in the detected velocity of the movement.

Thus, as the input means moves over the security feature, it gradually comes into effective contact with the electrically conductive elements, i.e. the input means gradually covers the electrically conductive elements. When the input means reaches an electrically conductive individual element, at this point in time the position of the resulting signal on the surface sensor is preferably shifted in the direction of the midpoint of the individual element which is in effective contact with the input means at this point in time. The center point is preferably defined as the geometric center of gravity (area center of gravity) of the individual element.

In one specific example, the input means is moved along an imaginary straight line in the y-direction at a uniform velocity on the object while the object is on the surface sensor and there is substantially no relative movement between the object and the surface sensor. As long as the input means does not come into contact with electrically conductive elements, the resulting time-dependent or displacement-dependent signal is characterized by touches differing substantially by the time stamp and the respective y-coordinate, with the velocity of the signal corresponding substantially to the velocity of movement of the input means (and is virtually constant). When the input means reaches an electrically conductive individual element, at this point in time the position of the resulting signal is preferably suddenly shifted in the direction of the individual element or, put more precisely, in the direction of the center of the individual element, i.e. the individual touch is shifted significantly more with respect to the y-coordinate compared to the preceding touches. Using the parameters of the individual touches of the resulting time-dependent signal, a velocity profile can be calculated. At the position where the input means reaches the electrically conductive individual element, the velocity profile exhibits a sudden sharp ascent, i.e. the velocity of the resulting signal is high in this region. If the input means moves further over the electrically conductive individual element, the velocity of the resulting signal gradually descends again until the input means has reached the center point or the geometric area center of gravity of the individual element. Upon further movement, the velocity ascends again slowly and then suddenly drops or descends with a significant negative ascent as soon as the input means leaves or is no longer in contact with the electrically conductive element. It is preferred within the meaning of the invention that fluctuations in the velocity profile can be detected in particular when the input means comes into contact with electrically conductive individual elements or the contact between input means and the electrically conductive individual elements is ended.

In other words, the signal changes abruptly at such points. Based on the “jumps”, i.e. based on the suddenly changed velocity of the time-dependent signal, the edges of electrically conductive elements can be clearly detected. Usually the velocity profile is asymmetric, i.e. a jump with a high ascent in velocity is followed by a slower descent in velocity. This ascent in the velocity profile can be investigated mathematically by determining and evaluating the slope of the curve. This asymmetry leads to a particularly reliable edge detection. The velocity profile of the time-dependent signal also changes abruptly when leaving an electrically conductive individual element. Due to the asymmetry of the signal, it is possible to detect during the decoding process whether the leading edge or the trailing edge of an electrically conductive individual element has been reached, i.e. whether the input means has reached or left an electrically conductive individual element at that moment. Thus, complex structures of the electrically conductive security feature can be detected. The terms leading edge and trailing edge or initial and end regions of an individual element are to be understood in relation to the respective direction of movement of the input means over the electrically conductive security feature.

In a preferred embodiment, the method is characterized in that a temporally asymmetrical curve of the velocity profile at the edges is taken into account in the detection of the edges using the velocity profile, wherein preferably at a leading edge a jump with a steep ascent in velocity is followed by a slow descent in velocity with a shallow descent. At a trailing edge, a steep drop is followed by a flat ascent.

In a preferred embodiment, the method is thus characterized in that the detection of the edges using the velocity profile takes into account a temporally asymmetric curve of the velocity profile at the edges, wherein preferably at a trailing edge a slow ascent in velocity is followed by a jump with a steep drop.

The terms steep ascent and shallow descent are preferably to be understood relative to each other and refer to the amount of change in velocity over a distance.

With respect to a velocity profile in the region of a leading edge, a velocity jump is preferably followed by a peak, which is followed by a drop in velocity. The ascent in velocity or slope of the velocity profile in the region before the peak is, in terms of absolute value, substantially greater than the descent or negative slope of the velocity after the peak. For example, the slope before the peak may be a factor of 2, 3, 4 or larger. The asymmetry may be defined figuratively in terms of a vertical axis passing through the peak, which divides the curve of the velocity profile into a region occurring before the peak and a region occurring after the peak. The region preceding the peak is not symmetrical with the region following it.

With respect to a velocity profile in the region of a trailing edge, a slow ascent in velocity is preferably followed by a peak, which is followed by a steep drop in velocity. The ascent in velocity or slope of the velocity profile in the region before the peak is, in terms of absolute value, substantially less than the descent or negative slope of velocity after the peak. For example, the slope before the peak may be lower by a factor of 2, 3, 4 or more. The asymmetry may be defined figuratively in terms of a vertical axis passing through the peak, which divides the curve of the velocity profile into a region occurring before the peak and a region occurring after the peak. The region preceding the peak is not symmetrical with the region following it.

These differences are highly characteristic of the occurrence of edges and can be reliably distinguished from other jumps or variations in the velocity profile. In addition, the occurrence of the asymmetries can also be correlated with the distribution of the conductive and non-conductive regions before and after the edges.

In a preferred embodiment, it can thus also be determined on the basis of a temporal asymmetric curve of the velocity profile in the region of the edges whether a leading edge, preferably at a start of a conductive region, or a trailing edge, preferably at an end of a conductive region, has been swiped with the input means. In the velocity profile of the time-dependent signal, the edges are respectively marked by peaks. Evaluation of the slope of the velocity profile before and after the peak enables a distinction to be made between leading edges and trailing edges.

In a further embodiment, a repetitive back-and-forth movement (swiping movement with oppositely alternating swipe direction) of the input means over the electrically conductive security feature is preferred. Advantageously, this results in multiple swipes over the edges in the different swipe directions. The combined evaluation of all “jumps” when arriving at and/or leaving the electrically conductive security feature or its individual elements allow an even more precise edge determination of the electrically conductive security feature. Thus, the internal structure or the “capacitive footprint” of the security feature can be determined even more precisely.

The term velocity profile preferably refers to the point-to-point velocity, i.e. the velocity between two touch events. It is calculated from the quotient of the path difference and the time difference of two successive touch events: v(y)=Δy/Δt. To illustrate the effect, a graphical representation of the point-to-point velocity or touch-to-touch velocity as a function of the coordinate along which the input means is moved, e.g. as a function of the y-coordinate of the touch screen, is useful. Such a representation may be referred to as a velocity profile of the signal, and may be processed and evaluated by a software algorithm as part of the decoding process. The velocity profile of the signal may be evaluated in a time-dependent manner or in a path-dependent manner. The characteristic signal generated on the surface sensor may be referred to as a time-dependent signal or a path-dependent signal.

As soon as an input is performed on a capacitive touch screen, the touch controller outputs a quantity of touch data or touch events, which are further processed by software on the terminal. With commercially available devices, this touch data substantially comprises the information
ID (identification number of the respective touch),
Type (touch start, touch move, touch end, touch cancel),
x-coordinate,
y-coordinate and
Timestamp.

Under certain conditions, a developer (of software for a mobile device with touch screen) gains access to further information, such as the diameter of the touches. With this data, the user's inputs can be reconstructed and appropriate or assigned actions can be triggered.

If an electrically conductive security feature is placed on a capacitive touch screen and a finger or other input device is swiped across the electrically conductive structure, the signal is modulated or changed by the combined influence of the input device (finger) and the electrically conductive structure. A set of touch data or touch events is thus output by the touch controller, which are characteristic of the electrically conductive security feature used as well as the input gesture by the user. This data is further processed by software on the terminal or sent to a server via a network connection and evaluated there.

The signal resulting from the combination of the input with an input means and the influence by an electrically conductive security feature differs from a reference signal without the influence of an electrically conductive security feature. The reference signal substantially maps the input gesture, i.e. the signal is characterized by a set of touch events that map the input as a data signal. For example, in the simplest case, the set of touch events comprises:
A Start Touch Event with the coordinates at the start position of the movement.
Multiple Move Touch events with different coordinates between Touch Start and Touch End
An End Touch event at the position where the gesture ended

All events are identified by time stamps and can therefore also be evaluated time-dependently. The term has been introduced herein for explanatory purposes. The generation of the reference signal is preferably not part of the invention.

The characteristic signal generated by the combination of the input with an input means and the influence of an electrically conductive security feature differs from the (virtual) reference signal. As soon as the input means comes into contact with the electrically conductive security feature or the electrically conductive structure and both objects (input means and electrically conductive structure) are in effective contact with the capacitive surface sensor, the time-dependent signal undergoes a change, e.g. in the form of a displacement, deviation, acceleration, deceleration, interruption, deletion, division or comparable effects. The signal also exhibits characteristic features when the finger or input means leaves the electrically conductive structure. If the electrically conductive structure is interrupted at a point, for example by a targeted demetallization, the characteristic signal at this point is usually characterized by an abrupt change in the direction of movement and/or the velocity of the movement.

The characteristic signals are preferably evaluated by software. In a preferred embodiment, a so-called machine learning model is trained with the characteristic signals, i.e. a set of signals for a particular electrically conductive security feature is recorded and characterized or classified on the basis of selected parameters. Suitable parameters include, but are not limited to:
Total duration of the signal
Length of the signal
Amplitudes of the signal
Signal length
Absolute number of touch events
Number of touch events per track (histogram)
Spatial density of the touch events
Distance to previous touch events
Event-to-event velocity
Symmetry of deviations

Most of the parameters mentioned can be determined for the entire signal as well as for sections or selected regions of the signal. The recorded data are assigned to classes by the machine learning model. With a sufficient amount of training data, the model can be used to classify any input or amount of touch data, i.e. to check for originality/authenticity.

In a further preferred embodiment, the method is characterized in that the characteristic signal is evaluated with respect to a velocity profile and the detection of edges is performed on the basis of the velocity profile. Due to the asymmetry of the velocity profile, it is therefore advantageously possible, inter alia, to detect whether the leading edge or trailing edge of an electrically conductive individual element has been reached, i.e. whether the input means has arrived at or left an electrically conductive individual element at that moment. If two electrically conductive elements, which are galvanically separated from each other, are close to each other and are in contact with the input means one after the other, the effects or impact of the trailing edge of the first element and the effects caused by the leading edge of the second element overlap. Thus, complex structures of the electrically conductive security feature can be detected. In the further course of the document, such an evaluation will be illustrated by means of embodiment examples.

In a further preferred embodiment, the method is characterized in that the characteristic signal is evaluated with respect to a velocity profile and edge detection is performed based on the velocity profile and the characteristic signal is additionally evaluated with respect to spatial deviations or other modulations. As known for example from WO 2018 141478 A1, by providing an electrically conductive structure preferably comprising a plurality of individual elements, a dynamic input can be deflected or modulated. What is preferably meant here is that the electrically conductive structure, or preferably its individual elements, are configured to cause a deflection of a signal on the surface sensor, the generated time-dependent signal being changed or modulated with respect to a reference input of an input means without an electrically conductive structure. The combination of different parameters in the evaluation of the touch data enables a greater variance and/or a higher degree of manipulation security.

The object or security feature according to the invention, which is suitable for capacitive readout according to the method described above, comprising an electrically conductive structure is characterized by the features described below. The electrically conductive structure is composed of a plurality of individual elements. These individual elements can be divided into two different types according to their function: active and inactive elements. Active elements are elements which are designed in such a way that they can be detected according to the described method, i.e. are suitable for generating a characteristic signal on a capacitive surface sensor. Such elements have a certain minimum size. Inactive elements (non-active elements, passive elements) are not detectable, i.e. they are so small that they do not generate a characteristic signal on a capacitive surface sensor or the signal that can be generated is not sufficiently different from a signal that can be generated only by input using input means without being combined with an electrically conductive element.

With regard to their maximum size, the (individual) elements are essentially limited by the fact that, above a certain size, they cause non-reproducible signals, interference signals or so-called touch-cancel effects.

In other words, the suitable sizes and geometries of the individual elements are determined by their detectability by a capacitive touch screen. The aim of the design process is on the one hand to provide individual elements that can generate reproducible signals, and on the other hand not to cause unwanted signals or interfering signals on the capacitive touch screen.

In the present description, the dimensions of the electrically conductive structure or electrically conductive security feature are preferably defined as follows: the width of the electrically conductive structure extends transversely or substantially orthogonally to the intended direction of movement of the input means; the length extends in the direction of movement or parallel to the intended direction of movement of the input means.

In a further preferred embodiment, the method is characterized in that the electrically conductive security feature comprises at least two individual elements or active regions whose spacing is at least 10 μm, preferably at least 50 μm. The preferred minimum spacing of two individual elements ensures in a particularly reliable manner that the characteristic signal to be detected advantageously reproduces a jump in the velocity profile at the transitions (edges) between the two regions, so that security features can be distinguished on the basis of the signal.

The spacing between two individual elements can preferably be constituted by a line-shaped interruption, for example by means of demetallization. The line-shaped interruption should therefore also preferably have a line width of at least 10 μm, preferably at least 50 μm.

In preferred embodiments, the line-shaped interruption and thus the spacing of the individual elements is less than 3 mm, preferably less than 2 mm, less than 1 mm. By means of extremely small line widths of the interruptions between 10 μm and 3 mm, preferably 50 μm to 2 μm or also 50 μm and 1 mm, a variety of different structuring can thus be carried out on a small area. In preferred embodiments, methods of demetallization, for example by means of a laser or chemical etching, are used for this purpose. It is known to the person skilled in the art that the production of demetallizations is subject to certain tolerances.

In this case, it may also be preferable to implement particularly thin line widths for the interruptions so that they are visually inconspicuous.

In some embodiments, the line-shaped interruption and thus the spacing of the individual elements may thus also preferably be less than 500 μm, less than 200 μm or less than 100 μm. Advantageously, even such thin interruptions are reliably detected by means of the edge detection according to the invention.

In a further preferred embodiment, the method is characterized in that the electrically conductive security feature comprises at least two individual elements or active regions whose width is between 1 mm and 15 mm and/or whose length is between 6 mm and 30 mm. The individual element can be configured in regions in the described sizes for length or width.

In another preferred embodiment, the length is the largest dimension of the individual element, with the width being substantially orthogonal to the length.

In another preferred embodiment, the electrically conductive security feature comprises at least two individual elements or active regions, wherein the area of each of the individual active elements is between 10 mm² and 450 mm².

The following table summarizes the dimensions of the individual elements as well as the design rules for the design of the electrically conductive security features. The relevant parameters of the electrically conductive structure are given respectively for inactive elements, i.e. non-detectable elements, and for active elements, i.e. detectable elements. The values given were determined by experiments on currently available, common smartphones with capacitive touch screens. The person skilled in the art will recognize that deviating types of surface sensors may require adapted design rules for the design of the electrically conductive structure.

| | Inactive elements | | Active elements | |
|---|---|---|---|---|
| | Minimum | Maximum | Minimum | Maximum |
| Width of an electrically | −>0 | <1 mm | 1 mm | 15 mm |
| conductive individual | | | | |
| element | | | | |
| Length of an electrically | −>0 | <3 mm | 6 mm | 30 mm |
| conductive individual | | | | |
| element | | | | |
| Distance between | 10 μm | unlimited | 10 μm | unlimited |
| electrically conductive | | | | |
| individual elements | | | | |
| Number of electrically | 0 | theo- | 2 | theo- |
| conductive individual | | retically | | retically |
| elements | | unlimited | | unlimited |
| Area of an electrically | −>0 | <8 mm² | 10 mm² | 450 mm² |
| conductive individual | | | | |
| element | | | | |

The total area of the electrically conductive structure is preferably at least 15 mm² and its maximum is limited by the size of the touch screen or touch display.

The orders of magnitude of the individual elements given in the above table as well as the design rules for the design of the electrically conductive security features relate to the features of the surface sensors in common use at the time of the preparation of this description. In particular, features such as the resolution of the surface sensors and the geometry of the electrode grid, e.g. distance between rows and columns of the electrode grid, influence the suitable orders of magnitude of the individual elements. In the following table, these magnitudes are generalized as multiples of the spatial period length L of the electrode grid of a surface sensor.

In a further preferred embodiment, the method is characterized in that the electrically conductive security feature comprises at least two individual elements or active regions whose width is between 0.2 L and 4 L and/or whose length is between 1.2 L and 8 L, where L preferably denotes the spatial period length of an electrode grid of a surface sensor.

| | inactive elements | | active elements | |
|---|---|---|---|---|
| | Minimum | Maximum | Minimum | Maximum |
| Width of an electrically | −>0 | <0.2*L | 0.2*L | 4*L |
| conductive individual | | | | |
| element | | | | |
| Length of an electrically | −>0 | <0.8*L | 1.2*L | 8*L |
| conductive individual | | | | |
| element | | | | |
| Distance between | 10 μm | unlimited | 10 μm | unlimited |
| electrically conductive | | | | |
| individual elements | | | | |
| Number of electrically | 0 | theo- | 2 | unlimited |
| conductive individual | | retically | | |
| elements | | unlimited | | |
| Area of an electrically | −>0 | <0.4*L² | 0.5*L² | 30*L² |
| conductive individual | | | | |
| element | | | | |

The total area of the electrically conductive structure is preferably at least 1*L² and its maximum is limited by the size of the touch screen.

The invention will be further illustrated below with reference to preferred embodiments.

In a particular embodiment, a capacitive touch screen may be used in a terminal for capacitive inspection of an electrically conductive security feature, for example a capacitive touch screen of a smartphone, tablet or in an information or self-service terminal. Bank notes, for example, often contain security strips or threads. By placing a bank note on a capacitive touch screen and performing a gesture along or across such a security feature, a characteristic dynamic signal is generated in the capacitive touch screen, which can be evaluated using software algorithms.

As described in more detail with reference to the figures below, for example, a gesture can be made along an electrically conductive structure or the security feature using an input means or finger. The electrically conductive structure is preferably in one or more parts and may comprise interruptions.

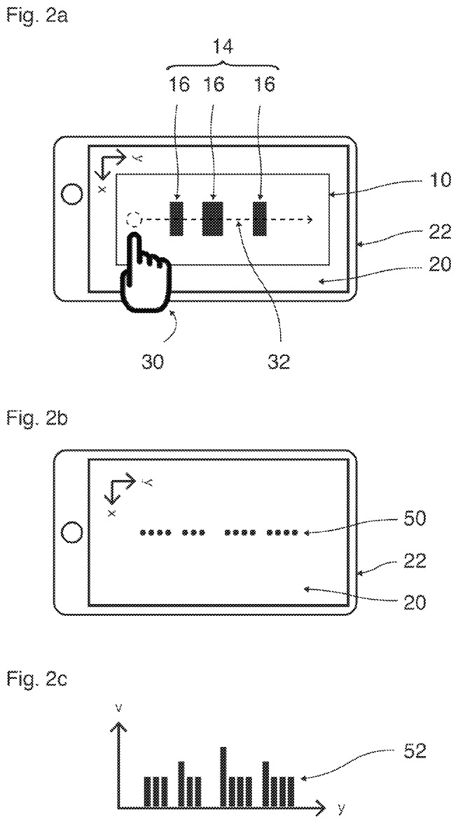

Advantageously, these interruptions or edges can be identified in the detected time-dependent signal. To clarify the signal curve, it is useful to record the touch events and to represent them, for example, as points at the corresponding xy coordinates (see FIG. 2). The touch events or dots appear on the touch screen gradually, i.e. offset in time. Corresponding to the edges of the electrically conductive structure on the security feature, interruptions or gaps occur in the otherwise substantially uniform curve of the touch points or the time-dependent signal.

Preferably, the evaluation is based on the velocity profile of the time-dependent signal (see FIG. 2c). For each touch point, a timestamp is available in common terminals with capacitive touch screens and can be used for the evaluation of the signal profile in the software. A velocity can be calculated for each touch event from the xy coordinates and the time stamps of the currently viewed touch event and the previous touch event (see FIG. 2c). In particular, edges and/or interruptions in the electrically conductive structure or the electrically conductive security feature cause jumps in the time-dependent signal when performing a swipe gesture using an input means, and thus changes in the velocity profile also become detectable. From this velocity profile, conclusions can be drawn about the shape, outline, internal structuring and/or contour of the electrically conductive structure and thus electrically conductive security features can be detected, authenticated, verified or distinguished.

In particular, the jumps in the time-dependent signal correlate with edges in an electrically conductive structure or security feature, i.e. preferably at transitions between conductive and non-conductive regions. Such detection is both particularly fast and reliable. Moreover, such a detection is particularly tamper-proof. It is practically impossible to generate such a signal without the presence of the electrically conductive security feature. It can thus be unambiguously proven that the security feature or the document (or object) including the security feature was present on the touch screen at the time of the input. This proof of presence of an object has many different fields of application.

In another preferred embodiment, the method is characterized in that the verification of the object comprises differentiation, verification, capacitive detection and/or authentication.

The terms “differentiation”, “verification”, “capacitive detection” and “authentication” are partially synonymous with each other and comprise the same and/or similar conceptual content. Within the meaning of the invention, verification, inter alia, preferably enables a “differentiation” between different security features, which in turn enables a “differentiation” between the objects to which the security features are applied. Authentication of a security feature, on the other hand, is preferably inspection of the authenticity of such a feature. Such an example of use may be highly relevant, for example, in the verification of bank notes with respect to counterfeiting.

In a further preferred embodiment, the method is characterized in that after the object has been placed on the surface sensor, the input means is placed on the electrically conductive security feature, and preferably the object is held pressed onto the surface sensor with it, whereby dynamic input is performed by pulling the object between the input means and the capacitive surface sensor. The described alternative generates the time-dependent signal (just like the previously described embodiments) by a relative movement between an input means and the security feature. Unlike the previous embodiments, the relative movement is caused by the security feature being “pulled through” while the input means is substantially fixed in place. The time-dependent signal generated on the capacitive touch screen in this case is essentially characterized by touch events oscillating around the position of the input means on the capacitive surface sensor, and this movement has a specific velocity profile.

Explanation of the Velocity Profile:

It may also be preferred, within the meaning of the invention, that variations in velocity occur, i.e. for example a fast movement of the input means is modulated into a slow time-dependent signal. It may also be preferred that the time-dependent signal has a specific velocity profile. For example, if an input means is moved along an imaginary straight line on the card-like object with no electrically conductive structures, then the surface sensor would detect as a reference input a time-dependent signal representing a straight line and having a nearly constant velocity. However, if a card-like object is now present between the input means and the surface sensor, on which the individual elements of the electrically conductive structure are present, for example, at specific intervals on the card-like object, then when an input means is moved on the card-like object, the surface sensor will detect a resulting signal which has a specific velocity profile. In this case, as the input means moves over the card-like object, the input means gradually comes into capacitive or galvanic effective contact with the electrically conductive elements on the card-like object, i.e. the input means gradually covers the electrically conductive elements. When the input means reaches an electrically conductive individual element, the position of the resulting signal is preferably shifted in the direction of the center of the individual element at this time.

In one specific example, the input means is moved along an imaginary straight line in the y-direction at a substantially uniform velocity on the card-like object. As long as the input means does not come into contact with electrically conductive elements, the resulting time-dependent signal is characterized by touches that differ substantially according to the time stamp and the respective y-coordinate, with the velocity of the signal essentially corresponding to the velocity of movement of the input means (and being nearly constant). If the input means reaches an electrically conductive individual element, at this point in time the position of the resulting signal is preferably shifted in the direction of the individual element or in the direction of the center of the individual element, i.e. the individual touch is shifted significantly more with respect to the y-coordinate compared to the preceding touches. A velocity profile can be calculated using the parameters of the individual touches or touch events of the resulting time-dependent signal. It is preferred within the meaning of the invention that variations in the velocity profile are particularly apparent when the input means comes into contact with electrically conductive individual elements. In other words, the signal changes abruptly at such points. Based on the “jumps”, i.e. based on the suddenly changed velocity of the time-dependent signal, the edges of electrically conductive elements can be clearly detected. Usually, the velocity profile is asymmetrical, i.e. a jump with a high ascent in velocity is followed by a slower descent in velocity.

The term velocity profile preferably refers to the point-to-point velocity, i.e. the velocity between two touch events. It is calculated from the quotient of the path difference and the time difference of two successive touch events: v(y)=Δy/Δt. To illustrate the effect, a graphical representation of the point-to-point velocity or touch-to-touch velocity as a function of the coordinate along which the input means is moved, e.g. as a function of the y-coordinate of the touch screen, is useful. Such a representation may be referred to as a velocity profile of the signal, and may be processed and evaluated by a software algorithm as part of the decoding process.

In the course of further evaluation of the velocity data, it may be useful, for example, to determine the mean value of the point-to-point or touch-to-touch velocity and to evaluate the overall signal with respect to the local deviation from the mean velocity. It may be further preferred to use all determined velocity values for further signal processing not as absolute numbers, but to convert them into relative data or to normalize the data. This step enables an evaluation of the signal which is largely independent of the velocity of movement of the input means.

Other suitable parameters for evaluating the signal include:
Total duration of the signal
Length of the signal
Amplitudes of the signal
Signal frequencies
Absolute number of touch events
Number of touch events per track (histogram)
Spatial density of the touch events
Distance to previous touch events
Symmetry of deviations

It is known to the person skilled in the art that the security feature or hologram is either located on the surface of the object or, in particular in the case of a multilayer card, is located on an inner layer of a multilayer body (object). If the electrically conductive security feature is preferably a so-called security thread, this is present, for example, partly on the surface and partly embedded in the paper. Such threads are already embedded into the paper during the manufacture of security paper, for example for the manufacture of bank notes. By means of the invention described herein, it is possible to electronically verify a conductive security feature even if it is partially or completely embedded within a multilayer object. The generation of a signal in the capacitive surface sensor is based on capacitive interactions between the surface sensor, the electrically conductive security feature, and possibly the input means. Direct galvanic contact is neither required to the input means nor to the surface sensor.

In a further aspect, the invention preferably relates to an object, preferably a document, a (bank) card or a product for carrying out the described method on a device having a capacitive surface sensor, wherein the object comprises an electrically conductive security feature and wherein the electrically conductive security feature has a structuring with conductive and non-conductive regions along at least one preferred direction, so that, after the object has been placed on the capacitive surface sensor and a dynamic input has been performed on the object by means of an input means for generating a characteristic time-dependent signal along the preferred direction, transitions from conductive and non-conductive regions can be detected as edges.

The person skilled in the art will recognize that preferred embodiments and advantages disclosed in connection with the method described at the beginning for verifying an object having an electrically conductive security feature on a device having a capacitive surface sensor apply equally to the claimed object. Likewise, described preferred embodiments of the object, in particular its security feature, can preferably be used in the claimed method.

In a further preferred embodiment, the invention relates to an object for carrying out a described method, the object comprising an electrically conductive security feature which has a structure with conductive and non-conductive regions along at least one preferred direction, so that, after the object has been placed on the capacitive surface sensor and a dynamic input has been performed on the object by means of an input means for generating a characteristic time-dependent signal along the preferred direction, a transition from conductive and non-conductive regions can be detected as edges.

In a further preferred embodiment, the object is characterized in that the geometry of the electrically conductive security feature, preferably its shape, outline, contour as well as internal structuring, in particular with regard to the presence of edges, determines the curve of the time-dependent signal in the capacitive surface sensor.

In another preferred embodiment, the object is characterized in that the electrically conductive security feature is applied on an electrically non-conductive substrate material.

In a further preferred embodiment, the object is characterized in that the electrically conductive security feature comprises at least two individual elements which are galvanically separated from one another, it preferably being possible to detect initial and/or end regions of the individual elements as edges when a dynamic input is performed on the electrically conductive security feature. In a further preferred embodiment, the object is characterized in that the structuring of the security feature is performed by demetallization, wherein the demetallization preferably comprises a removal of electrically conductive regions, preferably strip-shaped regions or line-shaped interruptions, by means of a chemical etching process or by means of a laser. Various demetallization processes are known to the person skilled in the art on the basis of his specialist knowledge or the standard literature (see inter alia Monika Kassmann (ed.), Grundlagen der Verpackung: Leitfaden für die fächerübergreifende Verpackungsausbildung, 2nd revised and extended edition 2014, DIN Deutsches Institut für Normung e.V. Beuth Verlag GmbH Berlin).

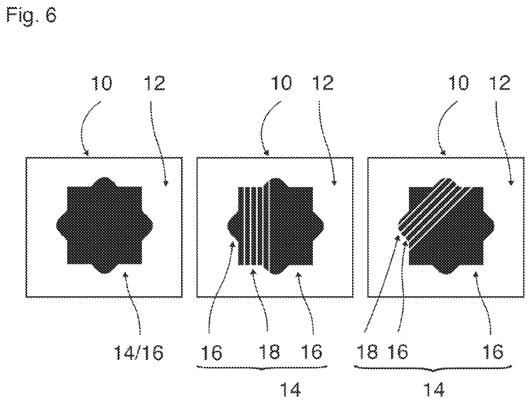

In a preferred embodiment, the object is characterized in that this one security feature comprises a planar, preferably substantially homogeneous, conductive region in which line-shaped interruptions (linear non-conductive regions) are present, the line-shaped interruptions preferably dividing the planar conductive region into two or more galvanically separated individual elements. Substantially homogeneous preferably means that the planar region is formed by a homogeneous surface with electrically conductive material except for the line-shaped interruptions (see for example FIG. 6). The line-shaped interruptions can preferably have small line widths of, for example, less than 3 mm, less than 2 mm, less than 1 mm, it being preferred that the line-shaped interruptions have a line width of at least 10 μm, preferably at least 50 μm, particularly preferably at least 100 μm.

In particular, more complex structuring can also be achieved, for example by star-shaped, circular, triangular, etc. non-conductive lines, which have been integrated into a flat, preferably substantially homogeneous, conductive region.

In a particularly preferred embodiment, the electrically conductive security feature, in particular a hologram, is partially or completely covered, for example by varnishing, overprinting, laminating, oversticking or similar methods known to the person skilled in the art. For carrying out the method according to the invention, it is irrelevant whether a cover layer is designed to be optically transparent or opaque, i.e. whether parts of the electrically conductive security feature are possibly covered. Due to the advantages of capacitive evaluation according to the invention, the covered security feature can nevertheless be detected in its complete (non-covered) form and characteristics.

By targeted demetallization of the electrically conductive security feature, i.e. the targeted removal of electrically conductive material, the signal in the capacitive surface sensor can be specifically changed. Such demetallization can be carried out either by partial printing of a (protective) lacquer and subsequent chemical etching process or, alternatively, very finely by means of a laser so that it is not visible to the human eye. However, such demetallization, which corresponds to a galvanic interruption in the electrically conductive security feature, changes the time-dependent signal on the capacitive surface sensor.

One embodiment of the invention comprises combining the electrically conductive security feature and an optically similar or identical looking electrically non-conductive color layer. With the aid of the electrically non-conductive color structure, the optical design of the electrically conductive security feature can be supplemented or extended or changed without this having any influence on the capacitive detection of the electrically conductive security feature, i.e. such electrically non-conductive elements have a passive effect on the touch screen. The purpose of such a combination of electrically conductive security features and additional electrically non-conductive elements is, for example, to hide demetallization, to enable greater degrees of freedom in the design of the security features, optical variations in the security feature, etc.

Another embodiment of the invention comprises combining the electrically conductive security feature with an additional electrically conductive layer, i.e. additional printed conductive elements are added. This additional electrically conductive layer may be visible or may be invisible or transparent. In any case, the additional electrically conductive layer or element alters the signal that is detectable on the touch screen. An additional electrically conductive ink as an electrically conductive layer can be applied using various printing methods, for example gravure printing, intaglio printing, intaglio, flexographic printing, screen printing, offset printing, inkjet printing or also foil application methods, such as cold foil application, hot stamping or thermal transfer printing. For electrically conductive, optically transparent layers, for example, materials based on electrically conductive polymers, metal oxides or carbon nanotubes are available.

In another preferred embodiment, the method described is characterized in that the electrically conductive security feature is modified by another printed electrically conductive element.

In a further preferred embodiment, the described method is characterized in that the electrically conductive security feature is present together with an electrically non-conductive element. This preferably corresponds to a combination of the electrically conductive security feature with an optically similar or identical looking electrically non-conductive ink layer.

In a preferred embodiment, the electrically conductive layer may be in direct contact with the electrically conductive security feature (galvanic contact). Alternatively, the use of a protective lacquer as an intermediate layer is also possible. In this case, a capacitive coupling exists between the electrically conductive security feature and the additional printed electrically conductive element. Also, a so-called release lacquer or primer or protective lacquer, which may cover the electrically conductive security element after application, prevents direct galvanic contact with the printed electrically conductive layer. This variation may be particularly advantageous, for example, to protect the metallization of the electrically conductive security feature from corrosion or interaction with constituents of the electrically conductive ink. The resulting signal on the touch screen is altered by the electrically conductive elements in any case, both in the case of galvanic and capacitive coupling.

A combination of the two embodiments mentioned (electrically conductive security feature combined with electrically non-conductive ink and electrically conductive security feature combined with electrically conductive ink) is of course also possible.

The electrically conductive structure or security feature is preferably constituted by electrically conductive regions on a non-electrically conductive substrate, wherein interruptions of the electrically conductive regions in the security feature, form non-conductive regions.

In a preferred embodiment of the invention, the substrate consists of an electrically non-conductive material, preferably a plastic, a paper, bank note paper, a cardboard, a composite, ceramic, textile or a combination of the aforementioned materials. In particular, the substrate is an electrically non-conductive material which is preferably flexible and light-weight. Translucent or opaque substrates may be used. Preferred plastics include in particular PVC, PETG, PV, PETX, PE and synthetic papers.

In a preferred embodiment, the security feature or the electrically conductive structure is formed by electrically conductive materials, preferably selected from a group consisting of electrically conductive inks, metals, metallized foils, metal particles or nanoparticles, electrically conductive particles, in particular carbon black, graphite, graphene, ATO (antimony tin oxide), electrically conductive polymers, in particular PEDOT:PSS (poly(3,4-ethylenedioxythiophene), polystyrene sulfonate), PANI (polyaniline), ITO, EDot, salts, polyacetylene, polypyrrole, polythiophene, conductive fibers, and other conductive material types or coatings, or a combination thereof.

Sheet resistance preferably refers to the electrical resistance of a material applied in a layer on a substrate. Typically, the electrical sheet resistance is abbreviated by Rₛ and has the unit (ohm/square). Particularly preferred are electrically conductive layers having an electrical sheet resistance of less than 100,000 ohms/sq, preferably less than 10,000 ohms/sq or 1,000 ohms/sq.

In a preferred embodiment, the area coverage of the electrically conductive material in the region of the electrically conductive structure or security feature is 100%. It may also be preferred that the area coverage of the electrically conductive material in the region of the electrically conductive structure is less than 100%, i.e. the electrically conductive structure is not completely filled with electrically conductive material. In this case, it is preferred that the individual elements of the electrically conductive structure are surrounded by a closed contour line. Within the contour line, the individual elements are filled with, for example, a grid, a modular grid or an irregular filling pattern configured to form electrically conductive paths within the respective individual element. This variation may be preferred, for example, to save electrically conductive material. It is preferred that the area coverage of the conductive material within the individual elements of the electrically conductive structure is greater than 25%, more preferably greater than 40% and most preferably greater than 60%.

In preferred embodiments, the electrically conductive structure or security feature may be applied to a preferably flexible substrate material of the card-like object by means of foil transfer methods, for example cold foil transfer, hot stamping, foil transfer methods and/or thermal transfer, without being limited to these application methods. In particular, printing methods, such as offset printing, gravure printing, flexographic printing and/or screen printing may be used to produce the card-like object and/or inkjet methods using electrically conductive inks based, for example, on metal particles, nanoparticles, carbon, graphene and/or electrically conductive polymers, without being limited to these printing methods and/or materials. It may also be preferred within the meaning of the invention to cover the electrically conductive structure by at least one further layer, which layer may be a paper-based or film-based laminate material or at least one lacquer/ink layer. This layer may be optically transparent or opaque.

In a further aspect, the invention preferably relates to a method of making and/or modifying an object having an electrically conductive security feature comprising
a. Provision of a security feature comprising an electrically conductive surface, preferably of metal, the security feature optionally being applied to a non-conductive substrate
b. At least partial demetallization of the surface to form a structure with conductive and non-conductive regions,
c. Optional application of the electrically conductive security feature on the object on a non-conductive substrate
so that an object with a security feature is obtained which has been modified by at least partial demetallization in such a way that, after placing the object with applied electrically conductive security feature on the capacitive surface sensor and making a dynamic input on the object by means of an input means for generating a characteristic time-dependent signal along a preferred direction, a transition from conductive and non-conductive regions can be detected as edges.

By such a procedure a security feature with a particularly flexible design can be obtained, which meets the highest security requirements and can thus also be used for the verification of particularly valuable objects (valuable documents) etc.

In this regard, the modification of the security feature may be performed both prior to application onto a non-conductive substrate, such as bank note paper, and subsequently. Rather, demetallization can preferably be performed both on exposed security features, which are optionally present on a carrier material, and on security features already applied to an object.

The term demetallization preferably means the removal of electrically conductive regions from a security feature. The term is known to the person skilled in the art in particular from the field of the design of holographic foils (preferably metal foils). In the context of the described process, the removed electrically conductive material may also be metal, but the term demetallization is also intended to mean the removal of other conductive materials within the meaning of the invention.

For example, the security feature can comprise an almost homogeneous planar electrically conductive region which is individualized by removing line-shaped strips of the electrical material (see FIG. 6). The interruptions created by the demetallization are preferably also called demetallizations.

In preferred embodiments, demetallization is performed using a laser beam and/or chemical etching.

In a further preferred embodiment, the method of manufacture and/or modification is characterized in that the conductive and non-conductive regions created by demetallization of the electrically conductive security feature are configured with respect to size, spacing, and shape such that the time-dependent signal on the capacitive surface sensor resulting from relative movement between an input means and the object is modified with respect to a reference signal established by a reference input with an input means without use of the object.

The person skilled in the art will recognize that preferred embodiments and advantages disclosed in connection with the method described at the beginning for verifying an object having an electrically conductive security feature on a device having a capacitive surface sensor apply equally to the claimed method for producing and/or modifying a security feature, and vice versa.

In a further aspect, the invention relates to a system for carrying out the described method, preferably for verifying an object with an electrically conductive security feature on a device with a capacitive surface sensor comprising
a. an object according to the invention or a preferred embodiment thereof
b. a device with a capacitive surface sensor

wherein the object comprises a security feature which is designed in such a way that, after placing the object on the capacitive surface sensor and performing a dynamic input on the object using an input means for generating a characteristic time-dependent signal, an evaluation of the time-dependent signal detected during the input on the surface sensor can take place, which evaluation comprises a detection of edges within the electrically conductive security feature.

The system according to the invention is preferably adapted to detect and evaluate the signal generated by the dynamic input to the surface sensor in order to verify the object.

In a preferred embodiment, the system comprises a data processing unit which is configured to evaluate the generated signal, wherein a software (‘app’) is preferably installed on the data processing unit comprising commands for evaluating the detected signal, in particular for detecting edges, and for comparing the detected signal with training data, wherein a verification of the object is preferably carried out via the evaluation of the signal and the comparison with training data and/or for transmitting information or characteristic data about the generated signal to a server device which is in data connection with the device and which is configured for an evaluation by means of the aforementioned commands, wherein the software is preferably configured to establish a secure data connection and to receive and display resulting statements of the commands executed on the server device.

The processing of the detected signal as a set of touch events is preferably performed by the operating system or the touch controller of the electronic device, such as a smartphone. The software (‘app’) installed on the data processing unit preferably evaluates the signal based on the detected set of touch events. The software preferably comprises commands for evaluating the detected time-dependent signal, as described in detail for the method. A person skilled in the art will recognize that the preferred embodiments or steps disclosed in connection with methods for evaluating the detected signal or comparing it with training data is preferably performed by the software (‘app’) comprising corresponding commands.

In a further preferred embodiment, the software is provided at least in part in the form of a cloud service or internet service, wherein the device transmits the touch data or touch events via the internet to an application in the cloud. Also in this case, software (‘app’) is provided on a data processing unit comprising commands for evaluating the detected signal, in particular for detecting edges, and for comparing the detected signal with training data, wherein preferably verification of the object is performed via the evaluation of the signal and the comparison with training data.

However, the software installed on the data processing unit of the device does not necessarily perform all computationally intensive steps independently on the device. Instead, the data about the detected time-dependent signal or the set of touch events is transmitted to a software application in a cloud (with an external data processing unit) for comparison with training data and/or for determining characteristics of the signal. In a preferred embodiment, the software for recording or acquiring the touch data may also be the browser of the device.

The software as a cloud service, which preferably comprises commands to compare the signal with training data, processes the signal in the form of a set of touch events and sends the result back to the device comprising the surface sensor or to software or the browser installed on the device. The software on the device can preferably further process the results and, for example, control their display.

When preferred features of the software are described below, a person skilled in the art recognizes that these preferably apply equally to software that performs the steps entirely on the device and to software that has outsourced some (preferably computationally intensive) steps, such as the determination of velocity profiles or the detection of edges and their comparison with training data, to an external data processing unit of a cloud service. A person skilled in the art will recognize that the intended evaluation of the detected signal is to be understood as a unified concept, regardless of which steps of the algorithm are performed on the device itself or by an external data processing unit on a cloud. In preferred embodiments, for example, a determination of a velocity profile for detecting edges of the signal may also be performed by the software on the device and a comparison of the edge or velocity profiles with training data outsourced by a cloud service.

In a further preferred embodiment, the system is characterized in that the device comprising the surface sensor processes the generated signal as a set of touch events and the software and/or the server device performs an evaluation based on the set of touch events.

A touch event preferably refers to a software event provided by the operating system of the device having the capacitive surface sensor when an electronic parameter detected by the touch controller changes.

An operating system preferably refers to the software that communicates with the hardware of the device, in particular the capacitive surface sensor or touch controller, and enables other programs, such as software (‘app’) to run on the device. Examples of operating systems for devices with a capacitive surface sensor include Apple's iOS for iPhone, iPad and iPod Touch or Android for running various smartphones, tablet computers or media players. Operating systems control and monitor the hardware of the device, in particular the capacitive surface sensor or a touch controller. Preferably, operating systems for the claimed system provide a set of touch events that reflect the detected signal.

A substantially rectilinear swipe motion as a dynamic input on the security feature may be recognized as, for example, a touch-start, a touch-move, and touch-end, and the x or y coordinates and timestamps of the touches are used to calculate the time history and a velocity profile.

If the swipe motion along a straight line on the y-axis occurs at a substantially uniform velocity on the security feature, then on average the velocities calculated from the touches correspond to the velocity of motion of the input means and are nearly constant. As explained in detail above, “jumps” in the velocity profile occur at transitions between conductive and non-conductive regions. In particular, the leading edge when reaching an electrically conductive individual element or its trailing edge when leaving it lead to characteristic ascents and descents in velocity. The software is preferably configured to calculate the velocity profile on the basis of the parameters of the individual touches or touch events and to analyze fluctuations or jumps in the velocity profile and thereby detect edges.

The data processing unit is preferably a unit suitable and configured for receiving, transmitting, storing and/or processing data, preferably touch events. The data processing unit preferably comprises an integrated circuit, a processor, a processor chip, a microprocessor and/or microcontroller for processing data, as well as a data memory, for example a hard disk, a random access memory (RAM), a read-only memory (ROM) or even a flash memory for storing the data. Corresponding data processing units are present in commercially available electronic devices with surface sensors, such as the mobile terminals or smart devices.

The software (‘app’) may be written in any programming language or model-based development environment, such as C/C++, C#, Objective-C, Java, BasicNisualBasic or Kotlin. The computer code may include subroutines written in a proprietary computer language specific to readout or control or another hardware component of the device. In particular, the software determines edges or jumps of the signal (preferably based on the set of touch events) in order to compare these to training data sets for verification.

For this purpose, the software, as described above, preferably acquires a velocity profile as well as, if necessary, further dynamic characteristics which characterize the detected signal during the performance of the dynamic inputs, in particular with regard to the presence of edges.

The dynamic characteristic data may preferably be local velocities, local maxima, minima, local deflections, and/or amplitudes of a set of touch events.

The totality of the dynamic characteristics, in particular comprising a velocity profile as well as their jumps or fluctuations and deviations, which characterize the detected signal, can preferably be combined in a data set which can be compared with a training data set in order to identify or verify the applied security feature.

In a preferred embodiment, the matching of the data set takes place using a machine learning model (artificial neural networks) previously created from records, training data or calibration data. For example, training data may be generated for this purpose in which the device with a security feature is placed on the surface sensor and a plurality of dynamic inputs, preferably swipe movements, are recorded. For example, a training data set on a specific security feature can be generated. Training data sets for a reference structure without edges or a more complex internal structure are also conceivable.

Preferably, the term training data refers to any data permitting a statement of the likelihood of a detected signal being generated on a security feature to be verified. Preferably, the training data may be stored on a computer-usable or computer-readable medium on the data processing unit. Any file format may be suitable which is used in the industry. The training data may be stored in a separate file or database and/or may be integrated into the software (e.g. in the source code). Preferably, the training data constitutes the basis of a statistical model computed by algorithms. After the learning phase, the statistical model is capable of classifying or interpreting any input data. In a preferred embodiment, the machine learning model is configured to continue learning during use even after the initial learning phase is complete, and thus the model becomes more accurate over time or can adapt to changing circumstances, such as new smartphones appearing on the market or counterfeits identified or discovered.

Due to the complexity of possible designs of security features and the high degree of accuracy with which software can reconstruct this given appropriate evaluation, such a verification is particularly secure and protected against manipulation. The use of a machine learning model to perform the verification of an object is particularly well suited for the evaluation of touch data, as these occur in great variance. Depending on the type of surface sensor of the device, the operating system, the design of the security feature, possible production variations or tolerances and the individual input by the user, a large number of different variants are all valid signals. In order to verify or detect these with a high degree of detection accuracy and certainty, the use of machine learning models is particularly suitable and preferred over static algorithms.

Based on the determination of further, preferably dynamic, characteristic values, the software can also perform a series of plausibility checks in order to rule out any manipulation of the signal.

For example, it may be preferred that for a swipe movement the software compares the time history of the input as well as the velocity profile with training data to check whether the symmetry or asymmetry of the jumps (regardless of their position in the security feature) occur with plausible probability for expected edges or interruptions.

The determination of the dynamic characteristics of the detected signal, in particular the velocity profile, and the comparison with training data sets, preferably allows both a check of the plausibility of the signal and its assignment to training data for verification or authentication purposes. The evaluation by means of the software may be implemented in various ways and may comprise several steps. Preferably, the device parameters of the device which includes the surface sensor, e.g. the resolution of the surface sensor or touch screen, can be determined first.

This allows the signal comprising a set of touch events step to be preferably pre-filtered and specific characteristics of the signal to be amplified or adapted. Advantageously, the software is thus not limited to a specific type of device, but can provide optimal results for different electronic devices.

After filtering the signal, the signal can be checked for plausibility by calculating parameters such as a temporal curve of the signal, velocity and data density. By means of a comparison with known or calibrated training data and/or a comparison with defined threshold values and/or processing by the statistical model, any manipulation can thus be reliably excluded.

Particularly preferably, a number of diverse characteristic values and parameters of the signals are subsequently determined or calculated. For this purpose, the characteristic values for start, end, movement, termination, the coordinates, information on geometric properties, a time stamp, local velocities, local maxima, minima, local deflections and/or amplitudes of the touch events can be determined, among other things.

In particular, the characteristic values should be suitable for comparing the detected signal as such as well as its modification by the electrically conductive security feature. Subsequently, the obtained data set and a training data set, which is located in a database, for example, can be compared in order to decode the signal, preferably using a machine learning algorithm. Decoding preferably means an assignment of the detected signal to an expected signal for a known security feature or the assignment of the detected signal to a class by the statistical machine learning model.

In another aspect, the invention relates to a kit for carrying out the method described at herein for verifying an object having an electrically conductive security feature on a device having a capacitive surface sensor comprising
a. an object for carrying out the method, comprising an electrically conductive security feature, the electrically conductive security feature having a structuring with conductive and non-conductive regions along at least one preferred direction, so that, after placing the object on the capacitive surface sensor and making a dynamic input on the object by means of an input means for generating a characteristic time-dependent signal along the preferred direction, transitions from conductive and non-conductive regions are detectable as edges, and
b. a software (‘app’) for installation on a device containing a surface sensor, which software comprises commands for evaluating the detected signal, in particular for detecting edges, and for comparing the detected signal with training data, wherein preferably a verification of the object takes place on the basis of an evaluation of the signal and a comparison with the training data and/or for transmitting information or characteristic data about the generated signal to a server device which is in data connection with the device, which is configured for evaluation by means of the aforementioned commands, the software preferably being configured to establish a secure data connection and to receive and display resulting statements of the commands executed on the server device.

Optionally, the kit may further comprise instructions for installing the software on the device and/or performing the described procedure.

The person skilled in the art will recognize that preferred embodiments and advantages disclosed in connection with the described method or object are equally applicable to the claimed system or kit, and vice versa.

It is noted that advantages, features and details of the foregoing description as well as of the following embodiments may each be preferred individually or also in any combination for realizing the invention. Thus, the disclosure relating to the individual aspects of the invention may always be referred to reciprocally.

### DETAILED DESCRIPTION

In the following, the invention will be explained in more detail by means of examples and figures, without being limited to these.

### FIGURES

### Brief Description of the Illustrations

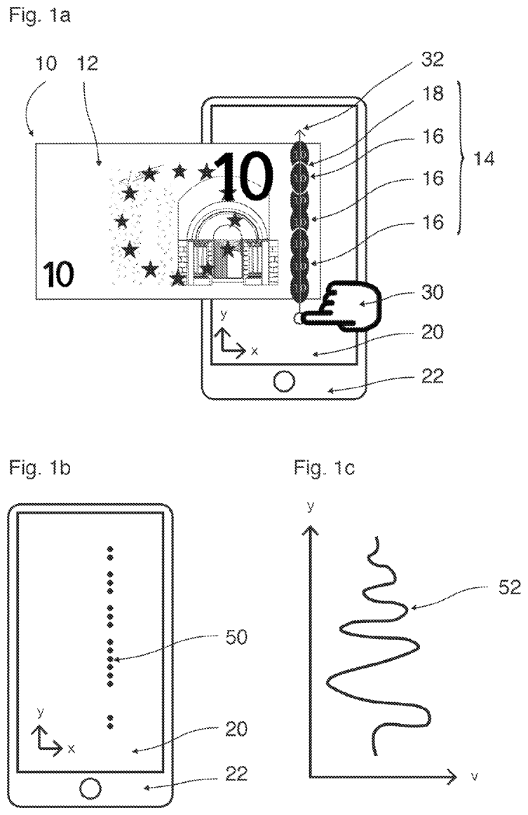

FIG. 1a-c Illustration of a preferred embodiment of the method using a value document (10 bank note) and a smartphone

FIG. 2a-c Illustration of a further embodiment of the method using a simple electrically conductive security feature with three individual elements and a smartphone

FIG. 3a-c Illustration of various preferred electrically conductive security features

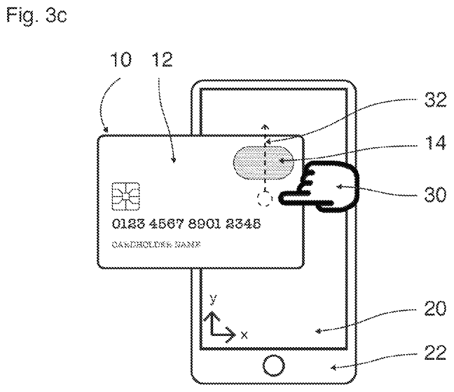

FIG. 4 Illustration of a preferred security feature in combination with a non-conductive ink layer

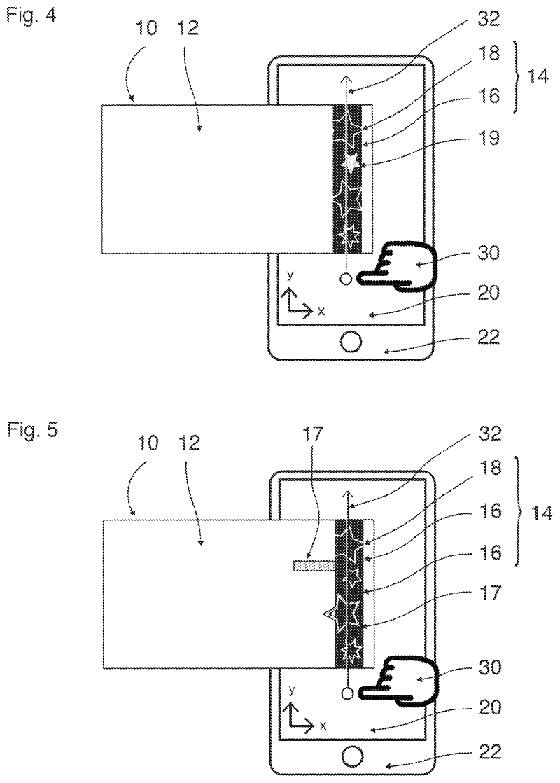

FIG. 5 Depiction of a preferred security feature with additional printed electrically conductive elements

FIG. 6 Schematic illustration of a possible modification of a hologram or security feature by means of demetallization

FIG. 7 Illustration of an alternative embodiment of the method in which a document of value with a security feature is pulled through between the input means and the capacitive surface sensor.

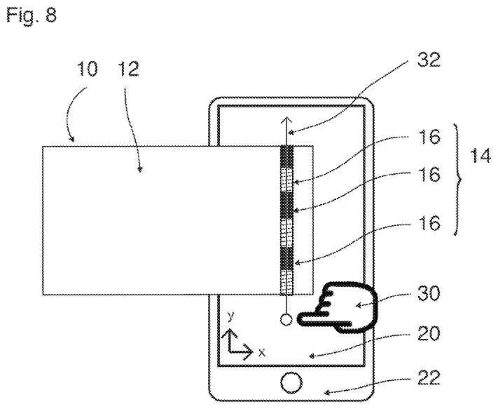

FIG. 8 Illustration of a bank note with a preferred security feature comprising a security thread or so-called window thread

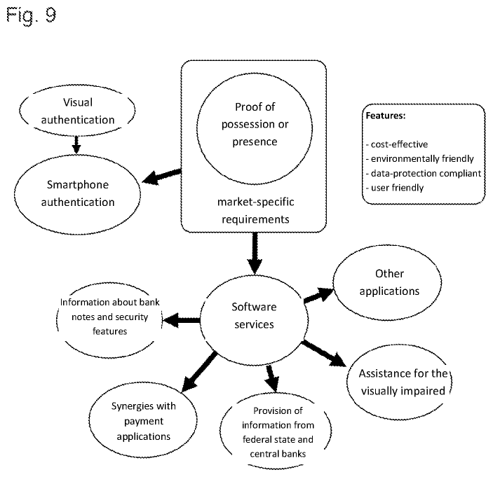

FIG. 9 Overview diagram illustrating further aspects of the invention

### DETAILED DESCRIPTION OF THE ILLUSTRATIONS

FIG. 1a shows a document of value 10, in particular a bank note, with an electrically conductive security feature 14 in the form of a security strip on a capacitive touch screen 20 of a terminal 22, as well as an input means 30 with which a gesture 32 is performed along the security strip 14. The signal curve of the time-dependent signal 50, the deflection as well as the velocity profile 52 of the signal are determined or fixed by the geometric shape of the electrically conductive feature 14 as well as the gesture 32 performed by means of input means 30 along the security strip 14, on the security strip 14 or parts thereof or transversely to the security strip 14.

The security features 14 of bank notes 10 of a series of bank notes typically differ in geometric shape, configuration or design, width, length, number of individual elements 16, design of connections between elements 16, presence of windows, position and design of demetallizations 18, and other features. The totality/sum of these features generates a characteristic signal 50 on a capacitive surface sensor 20 when the value document 10 is brought into contact with the capacitive surface sensor 20 and a gesture 32 is performed along the security feature 14 using an input means 30. This characteristic signal 50 may be a dynamic signal in the form of a time-dependent signal 52. From this, a so-called “capacitive footprint” of the security feature can be determined with the aid of software.

FIG. 1b shows a representation of the time-dependent signal 50. To illustrate the signal curve, it is useful to record the touch events and represent them, for example, as points at the corresponding xy coordinates. The touch events or dots are created on the touch screen 20 gradually, i.e. temporally offset and temporally correlated with the execution of the gesture 32. For clarity, the touch dots are displayed collected in the xy coordinate system of the capacitive touch screen 20 as if they had been recorded.

FIG. 1c shows the velocity profile 52 of the time-dependent signal 50. A timestamp is available for each touch point in common terminals 22 with capacitive touch screens 20 and can be used for evaluating the signal curve in the software. A velocity can be calculated for each touch event from the xy coordinates and the timestamps of the currently viewed touch event and the previous touch event. In the illustration of FIG. 1c, the velocity of the signal is shown as a function of the y-coordinate of the signal 50. Each security feature 14 has an individual velocity profile 52.

FIG. 2 a-c illustrates a method of detecting an electrically conductive security feature 14 with individual strips on a capacitive touch screen 20 based on velocity profile analysis.

FIG. 2a shows a document 10 having an electrically conductive structure 14 arranged on a substrate material 12. The document is placed on a capacitive touch screen 20 of a terminal 22, in this case on the capacitive touch screen of a smartphone. An input means 30 or finger is used to perform a gesture 32 along the electrically conductive structure 14. The electrically conductive structure 14 is in one or more parts and may comprise a plurality of electrically conductive individual elements 16 and have interruptions.

FIG. 2b shows the representation of the time-dependent signal 50. The representation corresponds to the signal representation of FIG. 1b. Referring to FIG. 2a, corresponding to the interruptions of the electrically conductive structure 14 on the document 10, interruptions or gaps can be seen in the otherwise substantially uniform curve of the touch points.

FIG. 2c shows the velocity profile 52 of the time-dependent signal 50. For each touch point or touch event, a time stamp is available in common terminals 22 with capacitive touch screens 20 and can be used for the evaluation of the signal curve in the software. A velocity can be calculated for each touch event from the xy coordinates and the time stamps of the currently viewed touch event and the previous touch event. This is shown in FIG. 2c. It can be seen that the electrically conductive structure 14 causes jumps in the signal and thus also changes in the velocity profile 52. From this velocity profile 52, conclusions can be drawn about the electrically conductive structure 14 and thus electrically conductive security features 14 can be detected, verified or distinguished.

FIG. 3a is an illustration of another electrically conductive security strip 14 applied to an object 10. As described in the previous figures, an input means 30 is used to perform a gesture 32 along the security strip 14, which rests on capacitive touch screen 20. The security strip 14 has different demetallizations 18 in the direction of a gesture 32. These may be in different shapes, for example star-shaped. In the area of the demetallizations 18, the electrically conductive security feature 14 is electrically interrupted, in some places over the entire width of the security feature 14 and in other places only partially.

FIG. 3b shows a value document 10, in particular a bank note with an electrically conductive security feature 14 in the form of a hologram patch, wherein the geometric shape of the conductive feature 14 and in particular also the demetallized regions 18 determine the deflection as well as the velocity profile 52 of the detected signal.

FIG. 3c shows an identification card 10, such as means of identification or bank card, with a hologram. Using an input means 30, a characteristic signal 50 can be generated on the surface sensor 20 by a gesture 32, as shown in FIGS. 1b and 2b.

FIG. 4 illustrates a further embodiment of the security feature 14 shown in FIG. 3a. Here, the electrically conductive security feature 14 is supplemented by an electrically non-conductive paint layer 19 with an identical optical appearance. It is thus not visually apparent to a user at which points the security feature 14 is electrically conductive or not electrically conductive or has demetallization 18. The purpose is, for example, to hide demetallizations 18 and to allow greater degrees of freedom in the design of the security features, etc.

FIG. 5 is an illustration of an embodiment wherein the electrically conductive security feature 14 is supplemented with an additional layer or additional printed electrically conductive elements 17. This additional layer 17 may be visible or may be invisible or transparent. In any case, it alters the signal. Combinations of the embodiments of FIG. 4 and FIG. 5 are also possible here.

FIG. 6 shows three different variants of a hologram 14, which differ with respect to the internal structure or the occurrence of edges. The holograms 14 or electrically conductive security features 14 all have the same external geometry and shape. They differ in terms of partial demetallization 18. The left hologram 14 has not been demetallized. The middle hologram 14 has been partially demetallized by vertical interruptions. The right hologram 14 has been altered by line-shaped demetallizations 18 at a 45° angle. These demetallizations 18 can be made so fine that they are not visible to the human eye, i.e. visually the three holograms 14 shown look the same. A reliable distinction or verification can nevertheless be made with the method according to the invention, advantageously by capacitive recognition by means of a commercially available smartphone.

FIG. 7 is an illustration of an alternative usage variant—As an alternative to the case described up to this point: the document 10 with security element 14 is placed on the surface sensor 20 and an input means 30 is swiped over the electrically conductive security element 14—the following interaction is possible:
Document/apparatus 10 is placed on the surface sensor 20
The input means 30 is placed on the electrically conductive security feature 14 (thereby pressing the document 10 onto the surface sensor 20)
The document 10 is pulled between the input means 30 and the capacitive touch screen 20.

As an alternative to the variants of use described so far, a further variant is shown in FIG. 7: The document 10 comprising an electrically conductive security feature 14 rests on the surface sensor 20 and is fixed or pressed onto the surface sensor 20 by an input means 30. The document 10 is now pulled between input means 30 and capacitive touch screen 20 such that the input means 30 comes into contact with the electrically conductive security feature 14. During this process, the input means 30 and the surface sensor 20 substantially do not move relative to each other. The security feature 14 comes into contact with the input means 30 as a result of this movement of the document 10, while the input means is already in operative contact with the surface sensor 20. At the same time, signal 50 on the capacitive touch screen 20 is deflected or altered.

FIG. 8 shows another embodiment. Bank notes 10 often contain a security thread or so-called window thread as a security feature 14. Such security threads 14 are embedded in the bank note paper 12 and come to the paper surface (window) at defined points in the bank note 10. In the top view, the security thread 14 is partially visible. In the transparent view, such window thread is visible in its entire length. To the viewer, it appears as if such a thread 14 is woven into the paper 12. This type of thread 14 is inserted into the bank note 10 during the papermaking process. The insertion of the metallized security thread 14 as a window thread into the paper 12 results in a characteristic capacitive signal, which can be evaluated by means of a touch screen 20 of a smartphone 22. The finger or input means 30 progressively comes into contact with window regions and non-window regions of the window thread 14 when performing the input gesture 32. In other words, the input means 32 is alternately in galvanic effective contact and in capacitive effective contact with the window thread, or the distance between the metallic thread 14 and the input means 30 varies depending on whether the input means is currently over a window area or in between during the input gesture. By making adjustments to the structure or design of such metallized security threads 14, reproducible signals can be generated and verified on a smartphone 22. Whenever the input means touches a boundary between window area and non-window area, the signal shows a significant change in, for example, velocity compared to the more or less constant velocity of movement of the input means 30.

FIG. 9 shows an overview diagram which, based on a market-specific security proof, illustrates two relevant aspects of the invention. A first application-side aspect relates to the authentication of bank notes 10 in combination with a smartphone 20, where the capacitive verification according to the invention can be complemented by optical authentication. A second aspect of the invention relates to a range of potential software services, for example:
Provision of information about bank notes 10 and their security features 14
Synergies with payment applications
Provision of information from the federal state banks and central banks
assisting citizens in recognizing the denomination, for example assisting visually impaired people

These applications can be provided by means of the capacitive detection of electrically conductive security features 14 according to the invention in a cost-effective, environmentally friendly, data protection-compliant and user-friendly manner.

### REFERENCE NUMERALS

10 Object, e.g. document or bank card
12 Substrate material
14 Electrically conductive security feature (hologram, strip, thread, patch)
16 Electrically conductive element
17 Printed electrically conductive element
18 Demetallization
19 Electrically non-conductive element
20 Capacitive touch screen or surface sensor
22 Device
30 Input device (finger, pen)
32 Dynamic input or operating track (gesture)
50 Display of the time-dependent signal
52 Velocity profile of the time-dependent signal

1. A method of verifying an object (10) having an electrically conductive security feature (14) on a device (22) having a capacitive surface sensor (20) comprising
a) providing a device (22) comprising a capacitive surface sensor (20)
b) providing an object (10) having an electrically conductive security feature (14)
c) placing the object (10) on the capacitive surface sensor (20)
d) performing a dynamic input (32) on the object (20) and on the electrically conductive security feature (14) using an input means (30) to generate a characteristic time-dependent and path-dependent signal on the surface sensor (20)
e) evaluating the characteristic time-dependent and path-dependent signal detected during input on the surface sensor (20), said evaluating comprising detecting edges within the electrically conductive security feature (14) wherein an edge is a transition between a conductive region and a non-conductive region and the edges are detected on the basis of a velocity profile (52) of the time-dependent and path-dependent signal taking into account a time-dependent and path-dependent asymmetrical curve of the velocity profile (52) at the edges.

2. The method according to claim 1
characterized in that
along at least one preferred direction of the security feature (14) a plurality of conductive and non-conductive regions alternate such that, when a dynamic input (32) is performed along said preferred direction, the transitions between conductive and non-conductive regions are detected as edges, wherein a leading edge is detected at a start point of a conductive region and a trailing edge is detected at an end point of a conductive region.

3. The method according to claim 1
characterized in that
the transition is established based on the asymmetrical curve of the velocity profile (52) in the region of the edges, whether a leading edge or a trailing edge, was swiped over with the input means (52).

4. The method according to claim 1
characterized in that
when detecting the edges using a velocity profile (52) taking into account an asymmetrical curve of the velocity profile:
at a leading edge, representing the start of a conductive region in relation to the dynamic input (32), a jump with a steep ascent in velocity is followed by a slow reduction in velocity with a shallow descent, wherein the absolute value of the slope of the ascent in the velocity profile is greater than the slope of the descent
and/or
at a trailing edge, representing the end of a conductive region in relation to the dynamic input (32), a slow ascent in velocity is followed by a jump with a steep descent, wherein the absolute value of the slope of the ascent in the velocity profile is greater than the slope of the descent.

5. (canceled)

6. (canceled)

7. (canceled)

8. The method according to claim 1
characterized in that
the geometry of the electrically conductive security feature (14) determines the curve of the time-dependent signal in the capacitive surface sensor (22).

9. (canceled)

10. The method according to claim 1
characterized in that
the electrically conductive security feature (14) comprises at least two individual elements (16) which are galvanically separated from one another.

11. The method according to claim 1
characterized in that
the dynamic input (32) comprises a substantially rectilinear swiping movement of the input means (30) across the entire security feature (14), the swiping movement being parallel or orthogonal to the largest dimension of the security feature (14).

12. The method according to claim 1
characterized in that
the dynamic input (32) can be performed as a swiping motion along one swipe direction and/or along oppositely alternating swiping directions in a multiple repetitive manner.

13. (canceled)

14. The method according to claim 1
characterized in that
the electrically conductive security feature (14) comprises at least two individual elements (16) or active regions whose spacing is at least 10 μm, or the electrically conductive security feature (14) comprises at least two individual elements (16) or active regions whose width is between 1 mm and 15 mm and/or whose length is between 6 mm and 30 mm, or the electrically conductive security feature (14) comprises at least two individual elements (16) or active regions, the area of the individual elements (16) each being between 10 mm² and 450 mm².

15. (canceled)

16. (canceled)

17. The method according to claim 1
characterized in that
the electrically conductive security feature (14) is complemented by a further printed electrically conductive element (17).

18. The method according to claim 1
characterized in that
the electrically conductive security feature (14) is co-existent with an electrically non-conductive element (19), the electrically non-conductive element (19) preferably being visually similar to the electrically conductive security feature.

19. The method according to claim 1
characterized in that
after placing the object (10) on the surface sensor (20), the input means (30) is placed on the electrically conductive security feature (14) and preferably the object (10) is held pressed therewith on the surface sensor (20), wherein a dynamic input (32) is effected by pulling the object (10) between the input means (30) and the capacitive surface sensor (20).

20. (canceled)

21. An object (10) for carrying out a method according to claim 1 on a device (22) having a capacitive surface sensor (20), the object (10) comprising an electrically conductive security feature (14)
characterized in that
the electrically conductive security feature (14) has a structure with conductive and non-conductive regions along at least one preferred direction, so that, after the object (10) has been placed on the capacitive surface sensor (20) and a dynamic input (32) has been performed on the object (10) using an input means (30) for generating a characteristic time-dependent signal along the preferred direction, one or more transitions from conductive and non-conductive regions can be detected as edges.

22. The object (10) according to claim 21
characterized in that
the geometry of the electrically conductive security feature (14), preferably its shape, outline, contour and internal structuring, in particular with regard to the presence of edges, determines the curve of the time-dependent signal in the capacitive surface sensor (20).

23. (canceled)

24. (canceled)

25. The object (10) according to claim 21
characterized in that
the structuring of the security feature (14) is realized by demetallization (18).

26. The object (10) according to claim 25
characterized in that
the demetallization (18) comprises a removal of electrically conductive regions by a chemical etching process or a laser.

27. A method of manufacturing and/or modifying an object (10) having an electrically conductive security feature (14) comprising
a) providing a security feature (14) comprising an electrically conductive surface, the security feature (14) optionally being applied to a non-conductive substrate (14)
b) at least partially demetallizing (18) the surface of the security feature (14) to form a structure having conductive and non-conductive regions,
c) optionally applying the electrically conductive security feature (14) to a non-conductive substrate (14)
so that an object (10) with a security feature (12) is obtained which has been modified by at least partial demetallization in such a way that, after the object (10) has been placed on the capacitive surface sensor (20) and a dynamic input (32) has been performed on the object (10) by an input means (30) for generating a characteristic time-dependent signal along a preferred direction, a transition from conductive and non-conductive regions can be detected as edges, wherein an edge is a transition between a conductive region and a non-conductive region and the edges are detected based on a velocity profile (52) of the time-dependent and path-dependent signal taking into account a time-dependent or path-dependent asymmetrical curve of the velocity profile (52) at the edges.

28. (canceled)

29. A system for carrying out a method according to claim 1 comprising
a) an object (10)
b) a device (22) with a capacitive surface sensor (20)
characterized in that
the object (10) comprises an electrically conductive security feature (14) which is designed in such a way that, after the object (10) has been placed on the capacitive surface sensor (20) and a dynamic input (32) has been performed on the object (10) by means of an input means (30) for generating a characteristic time-dependent signal, an evaluation of the time-dependent signal detected during the input on the surface sensor (20) can take place, the evaluation preferably comprising a detection of edges within the electrically conductive security feature (14) wherein an edge is a transition between a conductive region and a non-conductive region and the edges are detected based on a velocity profile (52) of the time-dependent and path-dependent signal taking into account a time-dependent or path-dependent asymmetrical curve of the velocity profile (52) at the edges.

30. A system according to claim 29
characterized in that
the system has a data processing unit which is configured to evaluate the generated signal, the data processing unit preferably having software (‘app’) installed thereon comprising commands for processing and evaluating the detected signal, wherein a verification of the object (10) is carried out on the basis of the evaluation of the signal and/or comprising commands for transmitting information or characteristic data about the generated signal to a server device which is in data connection with the device and which is configured for processing and evaluation by means of the aforementioned commands.

31. (canceled)

32. A kit for carrying out a method according to claim 1 comprising
a) an object (10) for carrying out the method comprising an electrically conductive security feature (14), the electrically conductive security feature (14) having a structure with conductive and non-conductive regions along at least one preferred direction so that, after the object (10) has been placed on the capacitive surface sensor (20) and a dynamic input (32) has been performed on the object (10) using an input means (30) for generating a characteristic time-dependent signal along the preferred direction, at least one transition of conductive and non-conductive regions can be detected as edges, wherein an edge is a transition between a conductive region and a non-conductive region and the edges are detected based on a velocity profile (52) of the time-dependent and path-dependent signal taking into account a time-dependent or path-dependent asymmetrical curve of the velocity profile (52) at the edges and
b) a software (‘app’) for installation on a device (22) containing a surface sensor (20), which software comprises commands, for processing and evaluating the detected signal, in particular for detecting edges.
